(19) United States
(12) Patent Application Publication
(10) Pub. No.: US 2026/0233775 A1
(43) Pub. Date: Aug. 13, 2026

(54) STROLLER

(71) Applicant: Wonderland Switzerland AG, Steinhausen (CH)

(72) Inventors: Tao Yang, Dongguan, Guangdong (CN); Pengcai He, Dongguan, Guangdong (CN); Erxue Wang, Dongguan, Guangdong (CN); Xiaolong Yi, Dongguan, Guangdong (CN)

(21) Appl. No.: 19/148,043

(22) PCT Filed: Jan. 18, 2024
(86) PCT No.: PCT/EP2024/051127

§ 371 Date: Jul. 15, 2025

(30) Foreign Application Priority Data
Jan. 18, 2023 (CN) 202310082485.2
Sep. 14, 2023 (CN) 202311193294.X

(51) Int. Cl. B62B 9/12; B62B 7/08; B62B 9/10

(52) U.S. Cl. CPC B62B 9/12; B62B 7/08; B62B 9/102; B62B 2206/06

(57) ABSTRACT

The present disclosure relates to a stroller, including a stroller frame, a seat assembly, a support rod set, and a locking mechanism. The seat assembly is movably arranged on the stroller frame and configured to carry a child. The support rod set is movably connected to the stroller frame and the seat assembly respectively. The support rod set is configured to adjust a height of the seat assembly. The locking mechanism selectively locks or unlocks the support rod set so that the seat assembly is fixed at a height position or the height of the seat assembly is adjustable. A seat height of the stroller can be easily and flexibly adjusted.

### CROSS-REFERENCE TO RELATED APPLICATIONS

This application is an U.S. national phase application under 35 U.S.C. § 371 based upon international patent application No. PCT/EP2024/051127 filed on Jan. 18, 2024, which itself claims priority to Chinese patent applications No. 2023100824852, filed on Jan. 18, 2023, and No. 202311193294X, filed on Sep. 14, 2023. The contents of the above identified applications are hereby incorporated herein in their entireties by reference.

### TECHNICAL FIELD

The present disclosure relates to the field of child carrier technologies, and in particular, to a stroller.

### BACKGROUND

In recent years, strollers have become a must-have for families with children. Seat heights of most strollers currently on the market cannot be adjusted, that is, the seat heights remain fixed relative to the ground, which cannot meet children's requirements of observing surrounding environments with a higher field of view and cannot be suitable for children of different heights to sit on.

### SUMMARY

Accordingly, there is a need to provide a stroller whose seat height can be easily and flexibly adjusted.

A stroller includes a stroller frame, a seat assembly, a support rod set, and a locking mechanism. The seat assembly is movably arranged on the stroller frame and configured to carry a child. The support rod set is movably connected to the stroller frame and the seat assembly respectively. The support rod set is configured to adjust a height of the seat assembly. The locking mechanism selectively locks or unlocks the support rod set so that the seat assembly is fixed at a height position or the height of the seat assembly is adjustable.

The seat assembly of the stroller is movably arranged on the stroller frame, and the height of the seat assembly can be adjusted through the support rod set movably connected between the stroller frame and the seat assembly, which can meet the children's requirements of observing the surrounding environments with different fields of view and can also be suitable for children of different heights to sit on. Through the locking mechanism, the support rod set can be locked or unlocked, so that a user can unlock the support rod set for adjustment when needing to adjust the height of the seat assembly or can lock the support rod set when adjusting the seat assembly to an appropriate height, causing the seat assembly to be fixed to the appropriate height.

In an embodiment, at least two support rod sets are provided, and the locking mechanism selectively locks or unlocks the at least two support rod sets synchronously.

In an embodiment, the support rod set includes a first lifting rod and a second lifting rod that are pivotally connected to each other, two ends of the first lifting rod are movably connected to the stroller frame and the seat assembly respectively, and two ends of the second lifting rod are movably connected to the stroller frame and the seat assembly respectively.

In an embodiment, one end of the first lifting rod is pivotally connected to the stroller frame, the other end of the first lifting rod is slidably connected to the seat assembly, one end of the second lifting rod is movably connected to the stroller frame, and the other end of the second lifting rod is pivotally connected to the seat assembly.

In an embodiment, the stroller further includes a sliding assembly, the sliding assembly being slidable relative to the stroller frame, and two ends of the second lifting rod are movably connected to the sliding assembly and the seat assembly respectively.

In an embodiment, the stroller further includes a sliding assembly, the stroller frame includes a support rod horizontally arranged, the sliding assembly being slidable relative to the support rod, one end of the second lifting rod is pivotally connected to the sliding assembly, and the other end of the second lifting rod is pivotally connected to the seat assembly.

In an embodiment, the stroller frame includes a connecting rod, the connecting rod being fixedly connected to the support rod, the sliding assembly is spaced apart from the connecting rod, the sliding assembly is movable in a direction close to or away from the connecting rod, and one end of the first lifting rod is pivotally connected to the connecting rod.

In an embodiment, the sliding assembly includes a sliding rod and a sliding seat, the sliding seat being fixed to one end of the sliding rod, the sliding seat further sleeving the support rod and being slidable along the support rod, and one end of the second lifting rod is pivotally connected to the sliding seat.

In an embodiment, one end of the first lifting rod is pivotally connected to the stroller frame, the seat assembly is provided with a sliding groove, and a sliding pin is fixed to the other end of the first lifting rod, the sliding pin being inserted into the sliding groove and movable along the sliding groove.

In an embodiment, the stroller further includes a sliding assembly, the sliding assembly being slidable relative to the stroller frame, the locking mechanism is arranged on the sliding assembly, and the locking mechanism selectively fixes the sliding assembly relative to the stroller frame or enables the sliding assembly to slide relative to the stroller frame.

In an embodiment, the locking mechanism includes:
a locking member movable arranged in the sliding assembly; and
an operating member arranged on the sliding assembly and drivingly connected to the locking member;
wherein the stroller frame is provided with a plurality of locking recesses, and the operating member is operable to cause the locking member to be disengaged from any of the locking recesses.

In an embodiment, the stroller frame includes a support rod arranged horizontally, the plurality of locking recesses being disposed on the support rod and arranged along a length direction of the support rod, and when the operating member is operated, the locking member is disengaged from any of the locking recesses, and the sliding assembly is slidable along the support rod.

In an embodiment, the locking mechanism further includes a lead pin, the lead pin being fixed to the locking member, and the operating member is provided with a first driving groove, the lead pin being inserted into the first driving groove and movable along the first driving groove, and when the operating member is operated, the lead pin being movable along the first driving groove in a direction away from the support rod.

In an embodiment, an extending direction of the first driving groove intersects with a moving direction of the locking member, and the extending direction of the first driving groove intersects with a direction in which the operating member is operated.

In an embodiment, the locking mechanism further includes a cover assembly, the cover assembly defining an accommodating space, at least part of the operating member is movably arranged in the accommodating space, and the other part of the operating member is capable of extending out of the accommodating space for operation.

In an embodiment, the cover assembly is provided with a second driving groove, the second driving groove extending along the moving direction of the locking member, and the lead pin is inserted into the second driving groove and movable along the second driving groove.

In an embodiment, the locking mechanism further includes a first reset member, the first reset member biasing to cause the locking member to move in a direction of engaging with any of the locking recesses.

In an embodiment, the stroller further includes an anti-accidental touch mechanism, the anti-accidental touch mechanism having a locked state and an unlocked state, when the anti-accidental touch mechanism is in the locked state, the locking mechanism keeps locking the support rod set, and when the anti-accidental touch mechanism is in the unlocked state, the locking mechanism is operable to unlock the support rod set.

In an embodiment, the stroller further includes an anti-accidental touch mechanism, the anti-accidental touch mechanism sleeving the sliding assembly and being movable along the sliding assembly, the anti-accidental touch mechanism having a locked state and an unlocked state, when the anti-accidental touch mechanism is in the locked state, the operating member is not operable to cause the locking member to be disengaged from any of the locking recesses, and when the anti-accidental touch mechanism is in the unlocked state, the operating member is operable to cause the locking member to be disengaged from any of the locking recesses.

In an embodiment, the anti-accidental touch mechanism includes:
an operating portion; and
a protruding portion capable of abutting against the operating member;
wherein, when the anti-accidental touch mechanism is in the locked state, the protruding portion is capable of abutting against the operating member, so that the operating member is not operable, and when the anti-accidental touch mechanism is in the unlocked state, the protruding portion is spaced apart from the operating member, so that the operating member is operable, and the operating portion is operable to cause the anti-accidental touch mechanism to switch from the locked state to the unlocked state.

In an embodiment, the anti-accidental touch mechanism further includes a second reset member, the second reset member biasing to cause the protruding portion to abut against the operating member.

In an embodiment, two support rod sets are provided and are respectively located on two sides of the seat assembly.

In an embodiment, the stroller further includes a sliding assembly, and the stroller frame includes two support rods horizontally arranged, the sliding assembly being slidable relative to the support rods.

In an embodiment, each of the support rod sets includes a first lifting rod and a second lifting rod that are pivotally connected to each other, two ends of each of the two first lifting rods are movably connected to the stroller frame and the seat assembly respectively, two ends of the sliding assembly are pivotally connected to one end of the two second lifting rods respectively, and the other end of each of the two second lifting rods is movably connected to the seat assembly.

In an embodiment, the locking mechanism includes:
two locking members movably arranged in the sliding assembly respectively, the two locking members being in opposite moving directions; and
an operating member arranged on the sliding assembly and drivingly connected to the two locking members respectively;
wherein each of the two support rods is provided with a plurality of locking recesses, and the operating member is operable to enable the two locking members to be disengaged from any of the locking recesses on the two support rods.

In an embodiment, the locking mechanism further includes a first reset member, two ends of the first reset member abutting against the two locking members respectively, and the first reset member biasing to cause the two locking members to move close to the two support rods respectively.

In an embodiment, a middle portion of the first lifting rod is pivotally connected to a middle portion of the second lifting rod.

In an embodiment, the locking mechanism includes:
a first operating member;
a connecting member provided with a first thread; and
a rotating member provided with a second thread in a threaded connection with the first thread; and
a driving assembly arranged between the first operating member and the rotating member;
wherein the first operating member is operable to drive, through the driving assembly, the rotating member to rotate relative to the connecting member.

In an embodiment, the stroller frame includes a connecting rod, the sliding assembly is spaced apart from the connecting rod, one of the connecting member and the rotating member is arranged on the connecting rod, the other of the connecting member and the rotating member is arranged on the sliding assembly, and when the rotating member rotates relative to the connecting member, the sliding assembly moves in a direction close to or away from the connecting rod.

In an embodiment, the support rod set includes a first lifting rod and a second lifting rod that are pivotally connected to each other, two ends of the first lifting rod are movably connected to the connecting rod and the seat assembly respectively, and two ends of the second lifting rod are movably connected to the sliding assembly and the seat assembly respectively.

In an embodiment, one end of the connecting member is fixed to the connecting rod, the other end of the connecting member is provided with the first thread, one end of the rotating member is provided with the second thread, and the other end of the rotating member is rotationally connected to the sliding assembly.

In an embodiment, the locking mechanism further includes:
a second operating member having a first operating position and a second operating position; and
two driving assemblies are provided, which are a first driving assembly and a second driving assembly respectively,
wherein, when the second operating member is at the first operating position, the first operating member is operable to drive, through the first driving assembly, the rotating member to rotate relative to the connecting member along a first rotation direction, and when the second operating member is at the second operating position, the first operating member is operable to drive, through the second driving assembly, the rotating member to rotate relative to the connecting member along a second rotation direction, the first rotation direction being opposite to the second rotation direction.

In an embodiment, when the rotating member rotates relative to the connecting member along the first rotation direction, a distance between the connecting rod and the sliding assembly decreases, and the height of the seat assembly increases; and when the rotating member rotates relative to the connecting member along the second rotation direction, the distance between the connecting rod and the sliding assembly increases, and the height of the seat assembly decreases.

In an embodiment, the other end of the rotating member away from the second thread is provided with a third gear portion;
the first driving assembly includes:
a first driving member in driving fit with the second operating member; and
a first gear having a first gear portion capable of meshing with the third gear portion; and
the second driving assembly includes:
a second driving member in driving fit with the second operating member; and
a second gear having a second gear portion capable of meshing with the third gear portion;
wherein, when the second operating member is at the first operating position, the first operating member is operable to cause, through the first driving member, the first gear to drive the third gear portion to rotate along the first rotation direction, and when the second operating member is at the second operating position, the second operating member is operable to cause, through the second driving member, the second gear to drive the third gear portion to rotate along the second rotation direction.

In an embodiment, the second operating member further has a third operating position, and when the second operating member is at the third operating position, the first operating member is operated, and the rotating member and the connecting member are relatively fixed.

In an embodiment, the first gear portion meshes with the third gear portion, the first driving member is switchable between a first driving position and a first spacing position, when the first driving member is at the first driving position, the first operating member is operable to drive, through the first driving member, the first gear to rotate, and when the first driving member is at the first spacing position, the first driving member is spaced apart from the first gear; and
the second gear portion meshes with the third gear portion, the second driving member is switchable between a second driving position and a second spacing position, when the second driving member is at the second driving position, the first operating member is operable to drive, through the second driving member, the second gear to rotate, and when the second driving member is at the second spacing position, the second driving member is spaced apart from the second gear.

In an embodiment, when the second operating member moves to the first operating position, the second operating member drives the first driving member to move from the first spacing position to the first driving position, and the second operating member drives the second driving member to move from the second driving position to the second spacing position; and when the second operating member moves to the second operating position, the second operating member drives the first driving member to move from the first driving position to the first spacing position, and the second operating member drives the second driving member to move from the second spacing position to the second driving position.

In an embodiment, the locking mechanism further includes a third reset member, the third reset member being adapted to bias the second operating member to cause the second operating member to move towards the first operating position or the second operating position.

In an embodiment, the third gear portion is in unidirectional meshing with the first gear portion and the second gear portion respectively; or the first gear is in unidirectional meshing with the first driving member, and the second gear is in unidirectional meshing with the second driving member.

In an embodiment, the first operating member is rotatably arranged on the sliding assembly, the first driving member and the second driving member are both arranged outside the sliding assembly and rotate coaxially with the first operating member, the first operating member is switchable between a first rotating position and a second rotating position, when the second operating member is at the first operating position, during rotation of the first operating member from the first rotating position to the second rotating position, the first driving member drives the first gear to rotate synchronously, and during rotation of the first operating member from the second rotating position to the first rotating position, the first gear is relatively fixed to the sliding assembly; and when the second operating member is at the second operating position, during rotation of the first operating member from the first rotating position to the second rotating position, the second driving member drives the second gear to rotate synchronously, and during rotation of the first operating member from the second rotating position to the first rotating position, the second gear is relatively fixed to the sliding assembly.

In an embodiment, a surface of the first driving member facing the first gear has a first main tooth portion, and a surface of the first gear facing the first driving member has a first auxiliary tooth portion, the first main tooth portion being in unidirectional meshing with the first auxiliary tooth portion; and a surface of the second driving member facing the second gear has a second main tooth portion, and a surface of the second gear facing the second driving member has a second auxiliary tooth portion, the second main tooth portion being in unidirectional meshing with the second auxiliary tooth portion.

In an embodiment, the locking mechanism further includes a fourth reset member, the fourth reset member being adapted to bias the first operating member to cause the first operating member to move from the second rotating position to the first rotating position.

In an embodiment, the first driving member and the second driving member are both located in a hollow inner cavity of the first operating member, the first operating member has an operating port connected to the hollow inner cavity, the first driving member has a first movable end, the first movable end having a first guide groove, the second driving member has a second movable end, the second movable end having a second guide groove, the locking mechanism further includes a guide post, one end of the guide post is fixed to the second operating member, the other end of the guide post is inserted into the first guide groove and the second guide groove through the operating port, an extending direction of the operating port is the same as moving directions of the first driving member and the second driving member, the operating port has a first sidewall and a second sidewall, when the second operating member is at the first operating position, the guide post abuts against the first sidewall, and when the second operating member is at the second operating position, the guide post abuts against the second sidewall.

In an embodiment, the locking mechanism further includes a third reset member, the third reset member being a torsion spring, one end of the torsion spring being fixed to the guide post, the other end of the torsion spring being fixed to the first operating member, and the third reset member being adapted to bias the second operating member to cause the second operating member to move towards the first operating position or the second operating position.

In an embodiment, the first driving member and the second driving member have an integrally formed structure.

In an embodiment, a surface of the first gear facing the third gear has a third main tooth portion, and a surface of the third gear facing the first gear has a third auxiliary tooth portion, the third main tooth portion being in unidirectional meshing with the third auxiliary tooth portion; and a surface of the second gear facing the third gear has a fourth main tooth portion, and a surface of the third gear facing the second gear has a fourth auxiliary tooth portion, the fourth main tooth portion being in unidirectional meshing with the fourth auxiliary tooth portion.

In an embodiment, the locking mechanism further includes a fixed seat, the fixed seat being fixed to the sliding assembly, the rotating member being rotatably arranged on the fixed seat, and the driving assembly and the first operating member are movably arranged on the fixed seat.

### BRIEF DESCRIPTION OF THE DRAWINGS

FIG. 1 is a schematic structural diagram of a stroller according to one aspect of the present disclosure, in which case a seat assembly is at a relatively low position;

FIG. 2 is another schematic structural diagram of the stroller shown in FIG. 1, in which case the seat assembly is at a relatively high position;

FIG. 3 is a side view of the stroller shown in FIG. 1;

FIG. 4 is a side view of the stroller shown in FIG. 2;

FIG. 5 is a schematic structural diagram of the stroller shown in FIG. 1 in a folded state;

FIG. 6 is a schematic structural diagram of the stroller shown in FIG. 2 in a folded state;

FIG. 7 is an enlarged view of portion A in FIG. 1;

FIG. 8 is an enlarged view of portion B in FIG. 2;

FIG. 9 is a partial exploded view of a locking mechanism and a sliding assembly;

FIG. 10 is a partial sectional view along a line C-C in FIG. 3;

FIG. 11 is an enlarged view of portion D in FIG. 10;

FIG. 12 is an enlarged view of portion E in FIG. 10;

FIG. 13 is a partial sectional view of the stroller according to another embodiment of the present disclosure;

FIG. 14 is an enlarged view of F in FIG. 13, in which case an anti-accidental touch mechanism is in a locked state;

FIG. 15 is another enlarged view of F in FIG. 13, in which case the anti-accidental touch mechanism is in an unlocked state;

FIG. 16 is a schematic structural diagram of a stroller according to another aspect of the present disclosure;

FIG. 17 is a side view of FIG. 16, in which case a seat assembly is at a relatively low position;

FIG. 18 is another side view of FIG. 17, in which case the seat assembly is at a relatively high position;

FIG. 19 is a schematic structural diagram of part of a stroller frame, a seat assembly, a support assembly, a sliding assembly, and a locking mechanism in FIG. 16;

FIG. 20 is a schematic structural diagram of the structure shown in FIG. 19 without a backrest;

FIG. 21 is a schematic structural diagram of the structure shown in FIG. 20 without the seat assembly;

FIG. 22 is an exploded view of the structure shown in FIG. 21 without a support rod and a connecting rod;

FIG. 23 is an enlarged view of a first driving assembly shown in FIG. 22;

FIG. 24 is an exploded view of the structure shown in FIG. 21 without the support rod and the connecting rod from another perspective;

FIG. 25 is an enlarged view of a second driving assembly shown in FIG. 24;

FIG. 26 is a partially exploded view of the structure shown in FIG. 21 without the support rod and the connecting rod from yet another perspective;

FIG. 27 is a top view of FIG. 21;

FIG. 28 is a sectional view taken along a line G-G in FIG. 21, in which case a second operating member is at a first operating position;

FIG. 29 is another sectional view taken along the line G-G in FIG. 21, in which case the second operating member is at a second operating position;

FIG. 30 is an enlarged view of portion I in FIG. 28; and

FIG. 31 is an enlarged view of portion J in FIG. 29.

### REFERENCE SIGNS

100: stroller frame, 110: armrest assembly, 111: front armrest, 112: side armrest, 120: front wheel frame, 130: rear wheel frame; 140: support rod, 141: locking recess, 150: connecting rod; 160: connecting member; 161: first thread,
200: seat assembly, 210: seat frame, 211: sliding groove, 220: seat post, 310: support rod set, 311: first lifting rod, 312: second lifting rod, 313: sliding pin, 320: sliding assembly, 321: sliding rod, 322: sliding seat, 322a: first sleeve portion, 322b: second sleeve portion, 322c: communication hole, 323: fixed ring,
400: locking mechanism, 410: locking member, 411: lug, 420: operating member, 421: first housing portion, 422: second housing portion, 423: connecting portion, 424: slot, 425: first driving groove, 430: cover assembly, 431: first cover, 431a: second driving groove, 432: second cover, 440: first reset member, 450: lead pin,
500: handle, 510: handle body, 520: handle bar, 600: front wheel assembly, 700: rear wheel assembly, 800: anti-accidental touch mechanism, 810: moving sleeve, 811: operating portion, 812: protruding portion, 820: second reset member,
910: fixed seat, 911: first fixed portion, 9111: mounting hole, 912: second fixed portion, 9121: engaging hook, 920: rotating member, 921: second thread, 922: third gear portion, 923: limiting protrusion, 930: first operating member, 931: pull-handle body, 932: first mounting portion, 933: second mounting portion, 934: hollow inner cavity, 935: operating port, 9351: first sidewall, 9352: second sidewall, 940: second operating member, 951: third reset member, 952: fourth reset member, 960: guide post, 970: first driving assembly, 971: first gear, 9711: first gear portion, 9712: first auxiliary tooth portion, 9712a: first auxiliary tooth, 9712b: first tooth surface, 9712c: second tooth surface, 972: first driving member, 9721: first driving body, 9721a: first main tooth portion, 9721b: first main tooth, 9722: first movable end, 9722a: first guide groove, 980: second driving assembly, 981: second gear, 9811: second gear portion, 9812: second auxiliary tooth portion, 9812a: second auxiliary tooth, 9812b: third tooth surface, 9812c: fourth tooth surface, 982: second driving member, 9821: second driving body, 9821a: second main tooth portion, 9821b: second main tooth, 9822: second movable end, 9822a: second guide groove,
M: pivot point, R1: first rotation direction, R2: second rotation direction, R3: third rotation direction, R4: fourth rotation direction.

### DETAILED DESCRIPTION OF THE EMBODIMENTS

In order to make the objectives, technical solutions, and advantages of the present disclosure clearer, the present disclosure will be further described in detail below in conjunction with the accompanying drawings and specific embodiments. It should be understood that the specific embodiments described herein are only intended to explain the present disclosure and do not limit the protection scope of the present disclosure.

It is to be noted that, when one element is referred to as “fixed to” the another element, it may be directly disposed on the another element or an intermediate element may exist. When one element is considered to be “connected to” another element, it may be directly connected to the another element or an intermediate element may co-exist. The terms “vertical”, “horizontal”, “left”, “right”, and similar expressions used herein are for illustrative purposes only, and do not represent unique implementations.

Unless defined otherwise, all technical and scientific terms used herein have the same meanings as would generally understood by those skilled in the technical field of the present disclosure. The terms used herein in the specification of the present disclosure are for the purpose of describing specific implementations only, and are not intended to limit the present disclosure. The term “and/or” used herein includes any and all combinations of one or more related listed items.

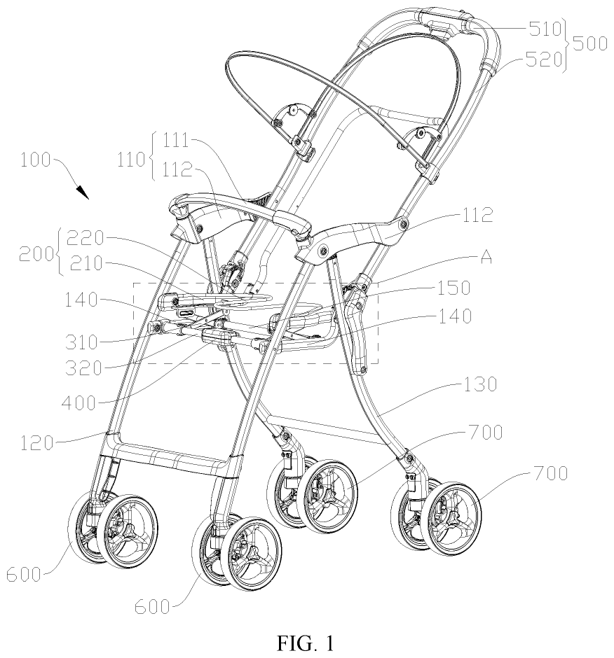

In one aspect of the present disclosure, a stroller is provided. As shown in FIG. 1 to FIG. 15, a height of a seat assembly 200 of the stroller may be conveniently and flexibly adjusted.

Specifically, as shown in FIG. 1, the stroller includes a stroller frame 100, a seat assembly 200, a support rod set 310, a sliding assembly 320, a locking mechanism 400, a handle 500, a front wheel assembly 600, and a rear wheel assembly 700.

Specifically, as shown in FIG. 1, the stroller frame 100 includes an armrest assembly 110, a front wheel frame 120, a rear wheel frame 130, a support rod 140, and a connecting rod 150. The armrest assembly 110 generally has a U-shaped structure, including a front armrest 111 and two side armrests 112 connected to two ends of the front armrest 111. The front wheel frame 120 and the rear wheel frame 130 both generally have an H-shaped structure. Two top ends of the front wheel frame 120 are connected to the two side armrests 112 respectively. Two bottom ends of the front wheel frame 120 are connected to two front wheel assemblies 600 respectively. Two top ends of the rear wheel frame 130 are connected to the two side armrests 112 respectively. Two bottom ends of the rear wheel frame 130 are connected to two rear wheel assemblies 700 respectively. The two top ends of the front wheel frame 120 and the two top ends of the rear wheel frame 130 are close to each other respectively, and the two bottom ends of the front wheel frame 120 and the two bottom ends of the rear wheel frame 130 are separated from each other respectively to form a stable triangular support. Two support rods 140 are provided, are respectively located on left and right sides of the stroller frame 100, and extend along a front-back direction of the stroller frame 100. Two ends of each support rod 140 are respectively connected to the front wheel frame 120 and the rear wheel frame 130. The connecting rod 150 extends along a left-right direction of the stroller frame 100, and two ends of the connecting rod 150 are respectively connected to two sides of the rear wheel frame 130 or two ends of the connecting rod 150 are respectively connected to the two support rods 140. It should be understood that directions such as “up”, “down”, “left”, “right”, “front”, and “back” referred to herein are based on the stroller in use as a reference.

Further, as shown in FIG. 1, the handle 500 generally has a U-shaped structure, including a handle body 510 and two handle bars 520 connected to two ends of the handle body 510. Each handle bar 520 is connected to the side armrest 112 and a rear wheel frame 130 on a same side, so that a user can push, through the handle 500, the stroller frame 100 to move.

Further, as shown in FIG. 1, the seat assembly 200 is movably arranged on the stroller frame 100 and configured to carry a child. The seat assembly 200 includes a seat frame 210, a seat rod 220, and a seat body (not shown). Two seat frames 210 are provided, are respectively movably arranged on left and right sides of the stroller frame 100, extend along front and back sides of the stroller frame 100, and are respectively located above the two support rods 140. The seat rod 220 is generally an S-shaped tube and is sinuously connected between the two support rods 140. The seat body covers the seat post 220 for a child to sit on.

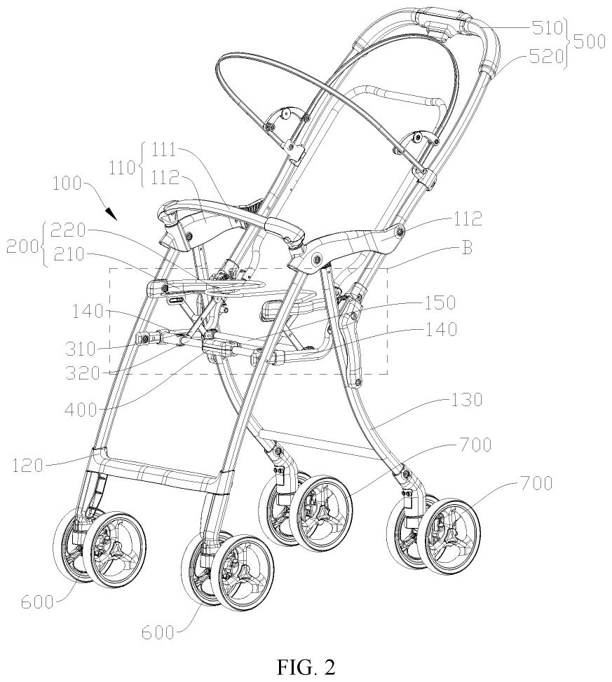

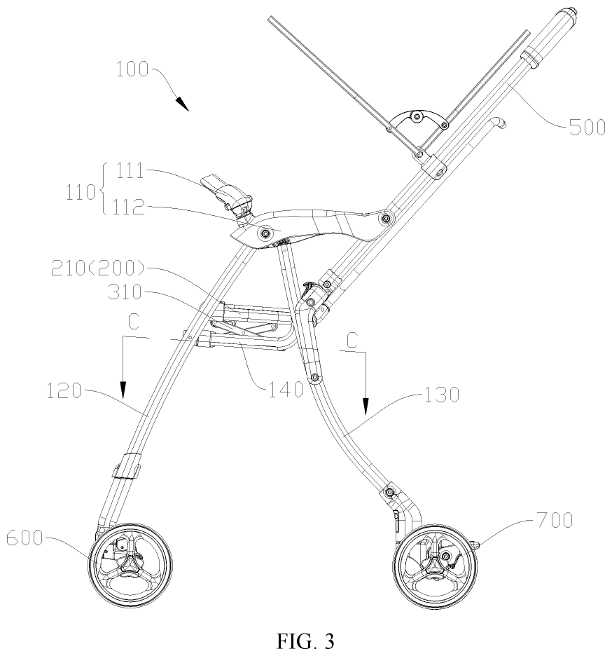

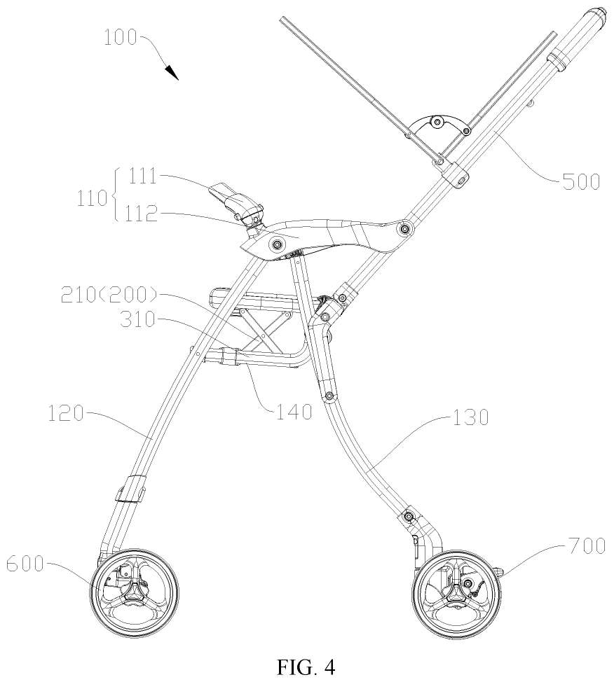

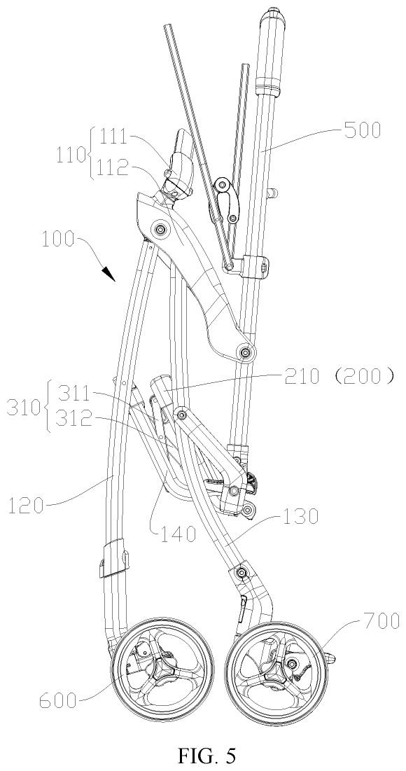

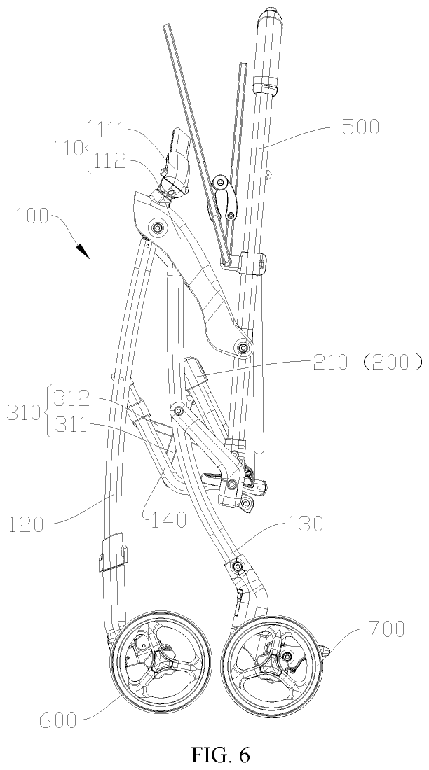

Further, the support rod set 310 is respectively movably connected to the stroller frame 100 and the seat assembly 200, and the support rod set 310 is configured to adjust a height of the seat assembly 200. For example, FIG. 1 and FIG. 3 show a state when the seat assembly 200 of the stroller is at a relatively low position, and FIG. 2 and FIG. 4 show a state when the seat assembly 200 of the stroller is at a relatively high position. Certainly, the seat assembly 200 of the stroller may not only have the two heights as shown in FIG. 1 to FIG. 4. That is, the seat assembly 200 may have two or more adjustment heights as required. The stroller of the present disclosure is a foldable stroller. FIG. 5 and FIG. 6 respectively show schematic structural diagrams of the stroller in a folded state when the seat assembly 200 is at a relatively low position and at a relatively high position.

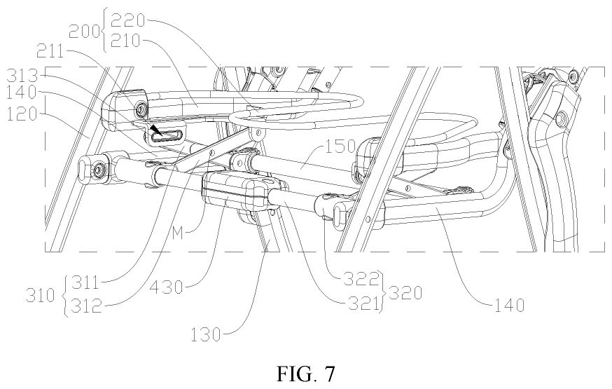

Specifically, as shown in FIG. 7, two support rod sets 310 are provided and are respectively located on two sides of the seat assembly 200. Each support rod set 310 is connected between the support rod 140 on a same side and the seat frame 210 on a same side. Certainly, in other embodiments, the number of the support rod set 310 may alternatively be more than two or less than two, and setting positions thereof may alternatively be adjusted as required.

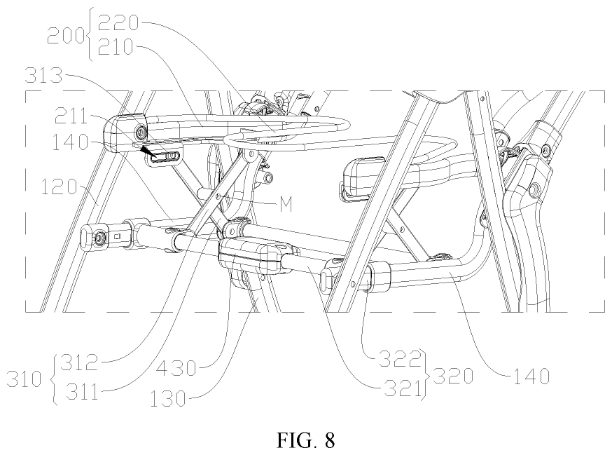

For example, one support rod set 310 is provided. As shown in FIG. 7 and FIG. 8, the support rod set 310 specifically includes a first lifting rod 311 and a second lifting rod 312. The first lifting rod 311 and the second lifting rod 312 are pivotally connected to each other at a pivot point M in an X shape. In this embodiment, a substantially middle portion of the first lifting rod 311 is pivotally connected to a substantially middle portion of the second lifting rod 312. Certainly, in other embodiments, the pivot position of the first lifting rod 311 and the second lifting rod 312 may alternatively be adjusted as required. A lower end of the first lifting rod 311 is pivotally connected to the connecting rod 150, and an upper end of the first lifting rod 311 is movably arranged on a front side of the seat frame 210. Specifically, a strip-shaped sliding groove 211 may be provided on the front side of the seat frame 210, the sliding groove 211 extends horizontally along the front-back direction of the stroller frame 100, a sliding pin 313 is fixed to the upper end of the first lifting rod 311, and the sliding pin 313 is inserted into the sliding groove 211 and can move along the sliding groove 211. In this way, the upper end of the first lifting rod 311 can move forward and backward relative to the seat frame 210. A lower end of the second lifting rod 312 is pivotally connected to the sliding assembly 320, and an upper end of the second lifting rod 312 is pivotally connected to an opposite rear side of the seat frame 210.

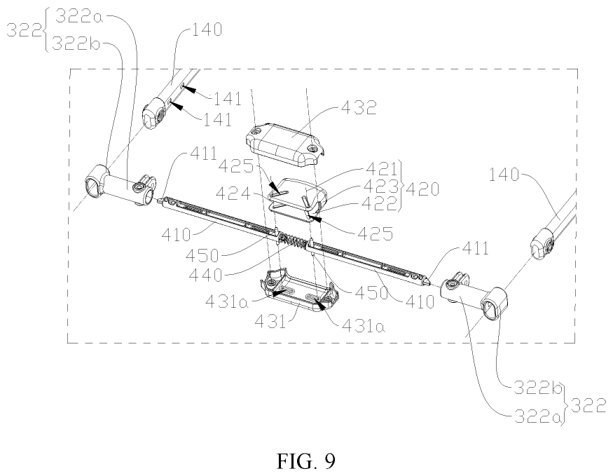

Specifically, as shown in FIG. 7, the sliding assembly 320 includes a sliding rod 321 and sliding seats 322 fixed to two ends of the sliding rod 321. The sliding rod 321 has a hollow rod structure. As shown in FIG. 9, each sliding seat 322 includes a first sleeve portion 322a and a second sleeve portion 322b that are connected and communicated with each other. The first sleeve portion 322a and the second sleeve portion 322b are arranged at an angle. In this embodiment, the first sleeve portion 322a and the second sleeve portion 322b are arranged perpendicularly to each other. Two ends of the sliding rod 321 are respectively inserted into and fixed to the first sleeve portions 322a of the two sliding seats 322. The two second sleeve portions 322b of the two sliding seats 322 sleeve the two support rods 140 respectively, and can move along the two support rods 140 respectively. As such, the sliding assembly 320 can move forward and backward relative to the two support rods 140. Certainly, in other embodiments, the movement of the sliding assembly 320 may alternatively be realized in other manners. For example, guide grooves may be respectively arranged on the two support rods 140, guide pins that can be inserted into the guide grooves and move along the guide grooves are respectively arranged at two ends of the sliding rod 321, and the like. In this embodiment, lower ends of the two second lifting rods 312 are respectively pivotally connected to the corresponding sliding seats 322, specifically pivotally connected to the first sleeve portions 322a of the corresponding sliding seats 322.

As such, when the sliding assembly 320 moves forward and backward relative to the two support rods 140, the lower end of the second lifting rod 312 may move to different positions relative to the support rod 140 on a same side. As shown in FIG. 7 and FIG. 8, in this case, since the lower end of the first lifting rod 311 is pivotally connected to the fixed connecting rod 150, a distance between the lower end of the first lifting rod 311 and the lower end of the second lifting rod 312 may decrease or increase. Since a position of the lower end of the second lifting rod 312 moves, the upper end of the second lifting rod 312 may also pivot around the pivot point M accordingly, so that the seat frame 210 connected to the upper end of the second lifting rod 312 moves along an up-down direction of the stroller frame 100, that is, the height of the seat assembly 200 changes, thereby adjusting the height of the seat assembly 200. At the same time, the seat frame 210, while driving the upper end of the first lifting rod 311 connected thereto to move up and down, may also drive the upper end of the first lifting rod 311 to move in the front-back direction of the stroller frame 100 through coordination between the sliding groove 211 and the sliding pin 313, thereby driving the lower end of the first lifting rod 311 to pivot around the pivot point M together. The angle between the first lifting rod 311 and the second lifting rod 312 may change. In the present disclosure, a distance between the sliding assembly 320 and the connecting rod 150 is controlled by sliding the sliding assembly 320 relative to the connecting rod 150, thereby controlling the angle between the first lifting rod 311 and the second lifting rod 312 to change to adjust the height of the seat assembly 200.

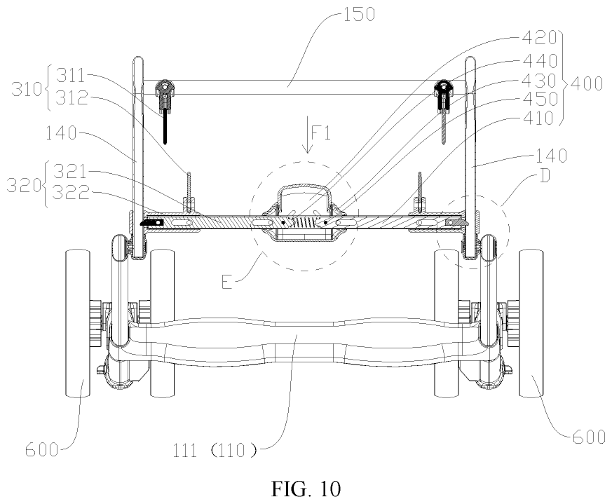

In a first aspect of the present disclosure, as shown in FIG. 9 and FIG. 10, a locking mechanism 400 is provided. The locking mechanism 400 selectively locks or unlocks the support rod set 310 so that the seat assembly 200 is fixed at a height position or the height of the seat assembly 200 is adjustable.

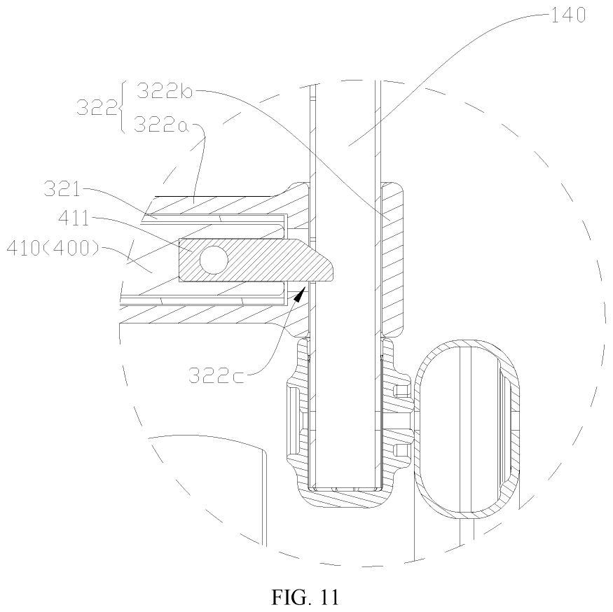

Specifically, the locking mechanism 400 includes a locking member 410, an operating member 420, a cover assembly 430, and a first reset member 440. In this embodiment, two locking members 410 are provided and both have a rod-shaped structure. The two locking members 410 are respectively movably arranged inside the sliding rod 321 and extend along a length direction of the sliding rod 321, and the two locking members 410 are in opposite moving directions. Ends of the two locking members 410 that are far away from each other are respectively provided with lugs 411, and the two support rods 140 are respectively provided with a plurality of locking recesses 141 (locking holes in this embodiment). The lugs 411 can be inserted into any locking recess 141 through a communication hole 322c (as shown in FIG. 11) between the first sleeve portion 322a and the second sleeve portion 322b. Each locking member 410 can move in a direction close to or away from the support rod 140 on the corresponding side, so that the lug 411 is inserted into or disengaged from any locking recess 141 of the support rod 140 on the corresponding side.

In this way, as shown in FIG. 9 to FIG. 11, taking the structure on the left side of the stroller as an example, when the lug 411 of the locking member 410 is inserted into different locking recesses 141, the sliding assembly 320 is fixed at different positions relative to the two support rods 140. That is, the lower end of the second lifting rod 312 is fixed at different positions relative to the support rod 140 on a same side. As shown in FIG. 7 and FIG. 8, in this case, since the lower end of the first lifting rod 311 is pivotally connected to the fixed connecting rod 150, the distance between the lower end of the first lifting rod 311 and the lower end of the second lifting rod 312 may decrease or increase. Since the position of the lower end of the second lifting rod 312 moves, the upper end of the second lifting rod 312 may also pivot around the pivot point M accordingly, so that the seat frame 210 connected to the upper end of the second lifting rod 312 moves along the up-down direction of the stroller frame 100, that is, the height of the seat assembly 200 changes. At the same time, the seat frame 210, while driving the upper end of the first lifting rod 311 connected thereto to move up and down, may also drive the upper end of the first lifting rod 311 to move in the front-back direction of the stroller frame 100 through coordination between the sliding groove 211 and the sliding pin 313, thereby driving the lower end of the first lifting rod 311 to pivot around the pivot point M together. As such, the height of the seat assembly 200 is adjusted.

Further, as shown in FIG. 9 and FIG. 10, the cover assembly 430 is arranged outside and is fixed to the sliding rod 321. The cover assembly 430 includes a first cover 431 and a second cover 432 that can be interlocked with each other. The first cover 431 and the second cover 432 define an accommodating space. At least part of the operating member 420 is movably arranged in the accommodating space, and the other part of the operating member 420 is capable of extending out of the accommodating space for operation. In this embodiment, the operating member 420 is an unlock button. Specifically, the operating member 420 has a hollow housing structure, and includes a first housing portion 421 and a second housing portion 422 arranged opposite to each other, and a U-shaped connecting portion 423 connected between the first housing portion 421 and the second housing portion 422. A slot 424 is formed between the first housing portion 421 and the second housing portion 422. When the operating member 420 moves relative to the sliding rod 321, the sliding rod 321 is at least partially located in the slot 424. The operating member 420 can be pressed to move in a direction F1 intersecting with an extending direction of the sliding rod 321. In this embodiment, the operating member 420 is pressed and can move in a direction perpendicular to the sliding rod 321. The operating member 420 is provided with a first driving groove 425. The first driving groove 425 passes through both the first housing portion 421 and the second housing portion 422. In this embodiment, two first driving grooves 425 are provided, and extending directions of the two first driving grooves 425 intersect with the moving direction F1 of the operating member 420 and also intersect with the extending direction of the sliding rod 321. Specifically, the extending directions of the two first driving grooves 425 gradually move away from each other along the direction F1 in which the operating member 420 is pressed.

Further, as shown in FIG. 9 and FIG. 10, lead pins 450 are respectively fixed to ends of the two locking members 410 close to each other, and the two lead pins 450 respectively pass through the sliding rod 321, are inserted into the two first driving grooves 425, and can move along the two first driving grooves 425 respectively. As such, when the operating member 420 is pressed in the direction F1, the two lead pins 450 move to a closer position along the two first driving grooves 425 respectively, so that the lugs 411 of the two locking members 410 originally inserted into the locking recess 141 are respectively detached from the inserted locking recesses 141, and the locking mechanism 400 unlocks the support rod set 310. In this case, the height of the seat assembly 200 can be adjusted by pushing and pulling the sliding assembly 320 forward and backward.

Further, as shown in FIG. 9, the first cover 431 is further provided with two second driving grooves 431a, and the two second driving grooves 431a extend along the extending direction of the sliding rod 321. Specifically, in order to maintain smoothness of the movement of the lead pins 450, the second cover 432 is also provided with two corresponding second driving grooves 431a, middle portions of the two lead pins 450 are respectively inserted into the two first driving grooves 425 and can move along the two first driving grooves 425 respectively, and end portions of the two lead pins 450 are respectively inserted into the upper and lower second driving grooves 431a of the first cover 431 and the second cover 432 and can move along the two second driving grooves 431a respectively. The arrangement of the second driving groove 431a can further constrain the lead pins 450 to move close to or move away from each other along the extending direction of the sliding rod 321.

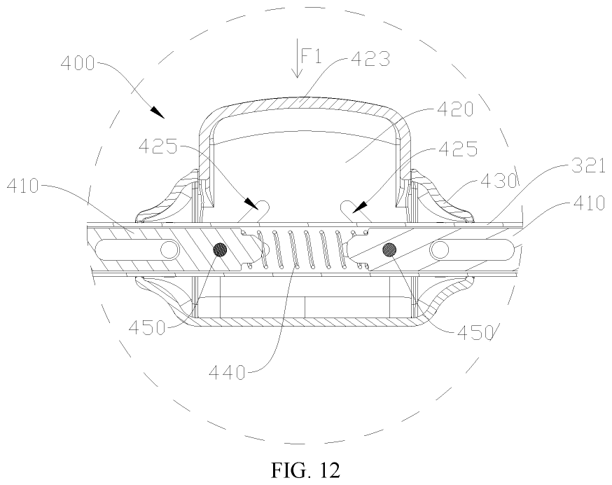

Further, as shown in FIG. 9 and FIG. 12, the first reset member 440 is arranged between the two locking members 410, and two ends of the first reset member 440 respectively abut against ends of the two locking members 410 close to each other. In this way, the first reset member 440 constantly causes the two locking members 410 to move in a direction close to the support rod 140 respectively. That is, after an external force pressing the operating member 420 is removed, the lugs 411 of the two locking members 410 can be automatically inserted into the corresponding locking recesses 141 again under the action of the first reset member 440, thereby fixing the seat assembly 200 to a required height. At the same time, through interaction between the two lead pins 450 and the two first driving grooves 425, the operating member 420 can alternatively be driven to be automatically reset. In this embodiment, the first reset member 440 is a spring.

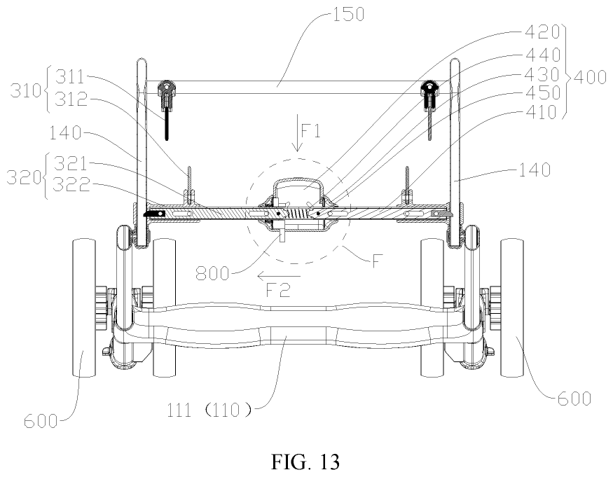

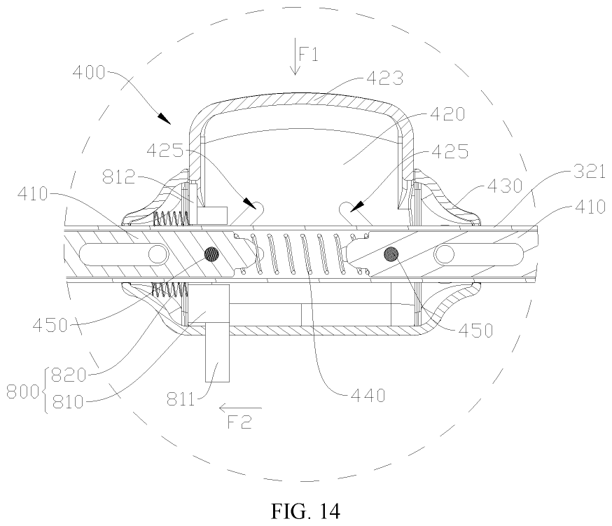

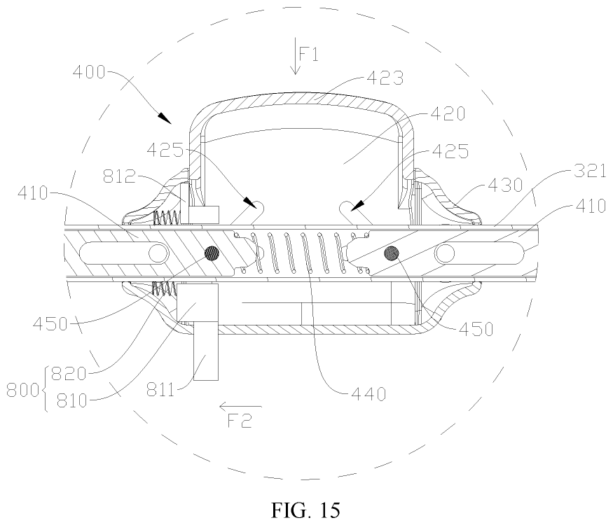

As such, in the above embodiments, the locking members 410 on two sides can be unlocked from the corresponding locking recesses 141 at the same time through the operating member 420, and the support rod sets 310 on two sides can be driven to pivot synchronously through the movement of the sliding rod 321, thereby realizing synchronous adjustment of heights of the left and right sides of the seat assembly 200. On the one hand, the height adjustment process of the seat assembly 20 is smoother. On the other hand, it is also easy to adjust the height of the seat assembly 200 with one hand, making the operation process simpler and more convenient. In another embodiment, as shown in FIG. 13 and FIG. 14, the child carrier may be further provided with an anti-accidental touch mechanism 800 to prevent accidental unlocking of the locking mechanism 400 caused by misoperation of the operating member 420. In this embodiment, the anti-accidental touch mechanism 800 includes a moving sleeve 810 and a second reset member 820. The second reset member 820 is arranged in the accommodating space. The moving sleeve 810 is arranged outside the sliding rod 321 and can move along the sliding rod 321. An operating portion 811 protruding out of the cover assembly 430 is provided on one side of the moving sleeve 810. In this embodiment, the operating portion 811 is a push button. A protruding portion 812 is provided on the other side of the moving sleeve 810. When the operating portion 811 is not operated, the protruding portion 812 abuts against the connecting portion 423. In this case, even if the operating member 420 is pressed in the direction F1, the operating member 420 cannot move. As such, the accidental unlocking of the locking mechanism 400 caused by the misoperation of the operating member 420 can be prevented. When the operating portion 811 is pushed in a direction F2 (in this embodiment, the direction F2 is parallel to the extending direction of the sliding rod 321), as shown in FIG. 15, the protruding portion 812 is spaced apart from the connecting portion 423. Specifically, the protruding portion 812 moves to the left side of the connecting portion 423 and no longer abuts against the connecting portion 423. That is, the anti-accidental touch mechanism 800 switches from a locked state to an unlocked state. In this case, the operating member 420 can be operated and moved. That is, the locking mechanism 400 can unlock the support rod set 310 only when the operating portion 811 and the operating member 420 are both operated. As such, accidental unlocking of the locking mechanism 400 can be prevented, thereby improving safety performance of the stroller. Certainly, in other embodiments, the anti-accidental touch mechanism 800 may alternatively be omitted.

Further, as shown in FIG. 14, the second reset member 820 constantly causes the protruding portion 812 to abut against the operating member 420. Specifically, the second reset member 820 is arranged outside the sliding rod 321, two ends of the second reset member 820 abut against the cover assembly 430 and the moving sleeve 810 respectively, and the second reset member 820 is located on a side of the protruding portion 812 away from the operating portion 811. That is, the second reset member 820 constantly pushes against the protruding portion 812 in a direction opposite to the direction F2. In this embodiment, the second reset member 820 is a spring.

The height adjustment process of the seat assembly 200 of the above stroller is specifically as follows.

As shown in FIG. 13 and FIG. 14, firstly, the operating portion 811 is pushed in the direction F2, so that the protruding portion 812 moves in the direction F2 without abutting against the connecting portion 423, the second reset member 820 is compressed and deformed, and the anti-accidental touch mechanism 800 switches to the unlocked state, as shown in FIG. 15. Then, the operating member 420 is pressed along the direction F1, so that the two lead pins 450 on the two locking members 410 move toward each other under the action of the two first driving grooves 425 and the two second driving grooves 431a respectively, and the two locking members 410 respectively move in a direction away from the support rod 140 on the corresponding side, until the lugs 411 on the two locking members 410 are respectively detached from the corresponding locking recesses 141, and at the same time, the first reset member 440 is compressed. As such, the locking members 410 on two sides of the locking mechanism 400 can be unlocked at the same time through one operating member 420, which is convenient to operate. In this case, as shown in FIG. 7 and FIG. 8, the height of the seat assembly 200 can be adjusted through the support rod set 310, that is, the sliding rod 321 can be pushed and pulled along the front-back direction of the stroller frame 100, so that the sliding seats 322 at two ends of the sliding rod 321 move along the support rods 140 on the two sides respectively. Taking the structure of the left side of the stroller as an example, the lower end of the second lifting rod 312 pivotally connected to the sliding seat 322 also moves to different positions relative to the support rod 140 on a same side. In this case, since the lower end of the first lifting rod 311 is pivotally connected to the fixed connecting rod 150, the distance between the lower end of the first lifting rod 311 and the lower end of the second lifting rod 312 may decrease or increase. Since the position of the lower end of the second lifting rod 312 moves, the upper end of the second lifting rod 312 may also pivot around the pivot point M accordingly, so that the seat frame 210 connected to the upper end of the second lifting rod 312 moves along the up-down direction of the stroller frame 100, that is, the height of the seat assembly 200 changes. At the same time, the seat frame 210, while driving the upper end of the first lifting rod 311 connected thereto to move up and down, may also drive the upper end of the first lifting rod 311 to move in the front-back direction of the stroller frame 100 through coordination between the sliding groove 211 and the sliding pin 313, thereby driving the lower end of the first lifting rod 311 to pivot around the pivot point M together. As such, the height of the seat assembly 200 is adjusted.

When the seat assembly 200 is adjusted to an appropriate height by moving the sliding rod 321, as shown in FIG. 15, an external force applied to the operating portion 811 and the operating member 420 can be canceled, and the two locking members 410 are reset under an elastic force of the first reset member 440, so that the lugs 411 on the two locking members 410 are inserted into the other corresponding locking recesses 141, thereby fixing the seat assembly 200 to a new height. At the same time, the operating member 420 is also reset in a direction opposite to the direction F1 under the action of the two lead pins 450 with the two first driving grooves 425 and the two second driving grooves 431a respectively. At the same time, the moving sleeve 810 is also reset in the direction opposite to the direction F2 under an elastic force of the second reset member 820, the anti-accidental touch mechanism 800 switches to the locked state, and the protruding portion 812 of the moving sleeve 810 abuts against the connecting portion 423 of the operating member 420 again (as shown in FIG. 14).

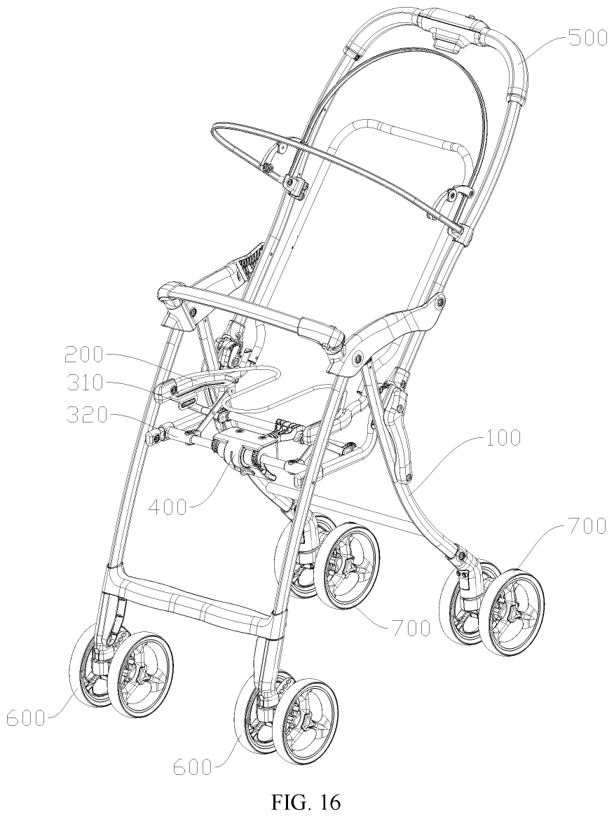

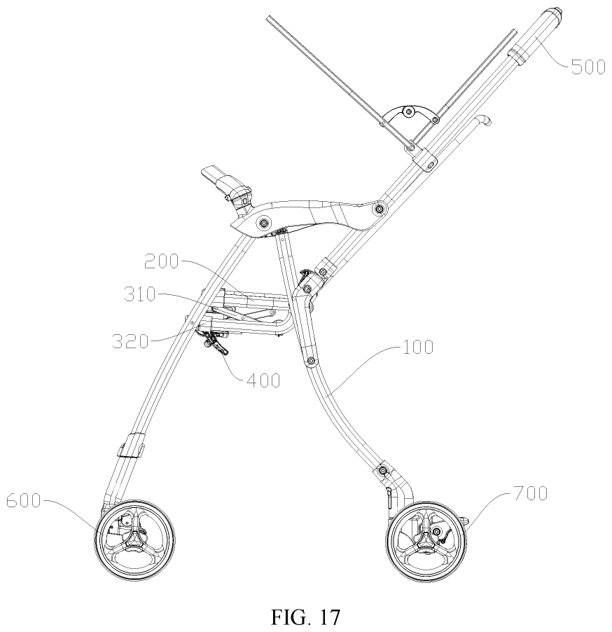

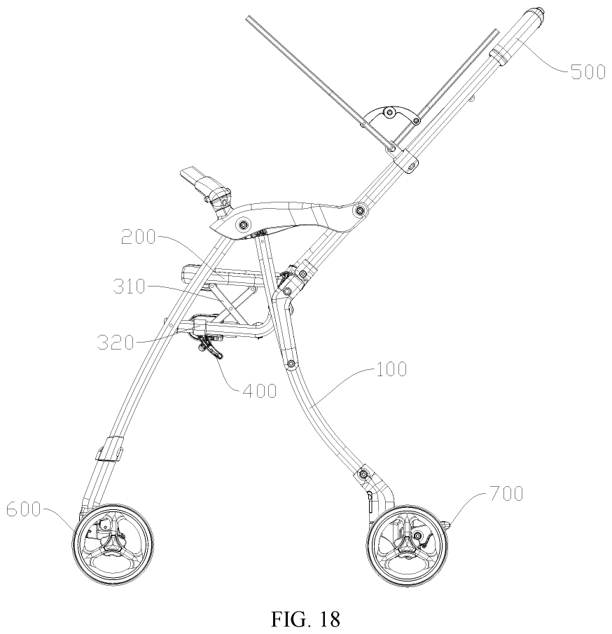

In a second aspect of the present disclosure, a stroller is provided. As shown in FIG. 16 to FIG. 27, the stroller also includes a stroller frame 100, a seat assembly 200, a support rod set 310, a sliding assembly 320, a locking mechanism 400, a handle 500, a front wheel assembly 600, and a rear wheel assembly 700. Structures of the stroller frame 100, the seat assembly 200, the support rod set 310, the sliding assembly 320, the handle 500, the front wheel assembly 600, and the rear wheel assembly 700 of the stroller in this embodiment are the same as those in the foregoing embodiment, and a difference merely lies in the specific structure of the locking mechanism 400.

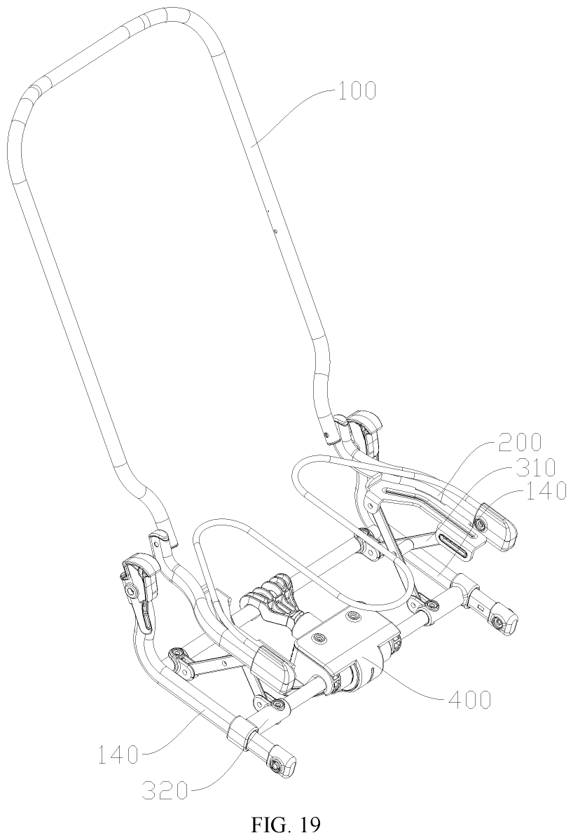

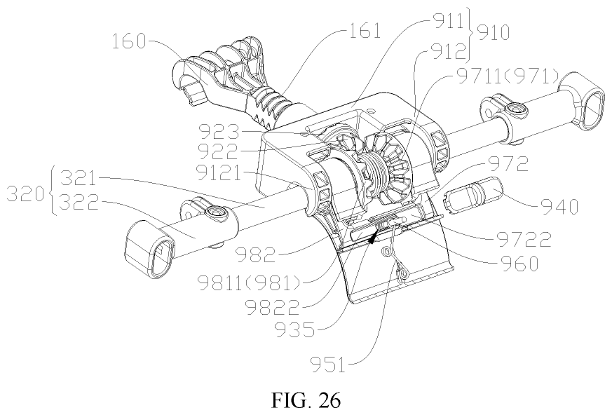

Specifically, as shown in FIG. 19 to FIG. 22, the locking mechanism includes a fixed seat 910, a rotating member 920, a first operating member 930, a driving assembly, a second operating member 940, a third reset member 951, a fourth reset member 952, a guide post 960 (see FIG. 26), and a connecting member 160.

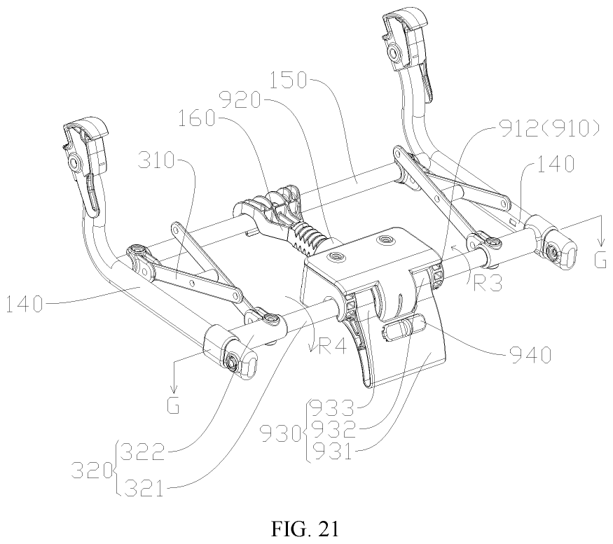

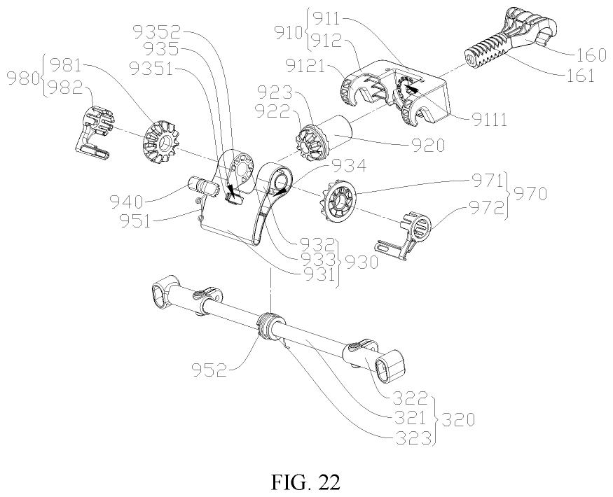

Further, as shown in FIG. 21 and FIG. 22, the fixed seat 910 generally has a U-shaped structure, and includes a first fixed portion 911 and second fixed portions 912 connected to two ends of the first fixed portion 911. Ends of the two second fixed portions 912 away from the first fixed portion 911 are each provided with an engaging hook 9121. The fixed seat 910 is engaged with and fixed to the sliding rod 321 through the two engaging hooks 9121. A substantially middle portion of the first fixed portion 911 is provided with a mounting hole 9111.

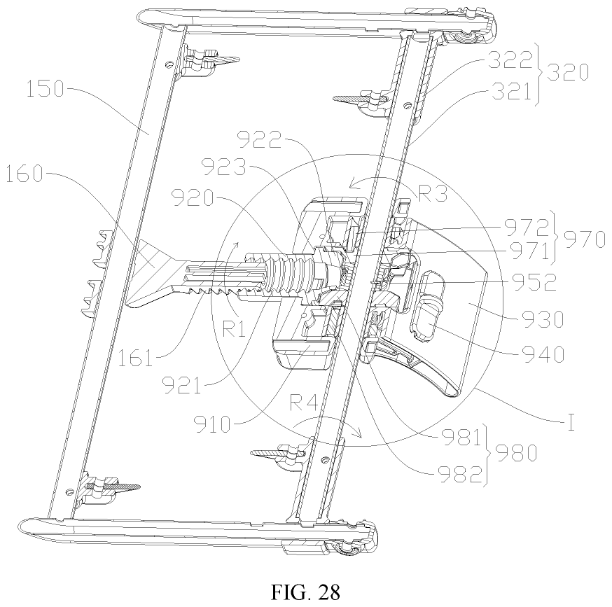

Further, as shown in FIG. 22 and FIG. 28, the rotating member 920 is rotatably arranged on the fixed seat 910 and passes through the mounting hole 9111. The rotating member 920 generally has a cylindrical structure. One end of the rotating member 920 is provided with a second thread 921. In this embodiment, the second thread 921 is an internal thread. The other end of the rotating member 920 is provided with a third gear portion 922. The third gear portion 922 of the rotating member 920 protrudes from the rotating member 920 along a radial direction of the rotating member 920 to form a limiting protrusion 923. When the rotating member 920 is mounted on the fixed seat 910, one end of the rotating member 920 with the second thread 921 passes through the mounting hole 9111 and extends towards the connecting rod 150, while the limiting protrusion 923 abuts against a surface of the fixed seat 910 away from the connecting rod 150, so that the third gear portion 922 is limited to the side of the fixed seat 910 away from the connecting rod 150.

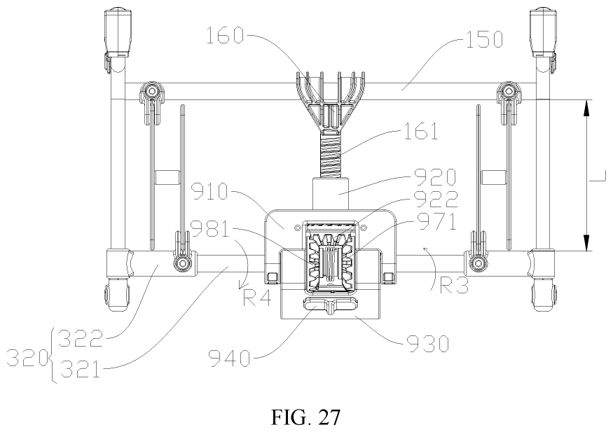

In this embodiment, as shown in FIG. 27 to FIG. 29, one end of the connecting member 160 is fixed to the connecting rod 150, and the other end of the connecting member 160 is provided with a first thread 161 that can be in a threaded connection with the second thread 921. The other end of the connecting member 160 is connected to one end of the rotating member 920 through the threaded connection between the first thread and the second thread. In this embodiment, the first thread 161 is an external thread. Certainly, in other embodiments, the first thread 161 may alternatively be an internal thread, while the second thread 921 is an external thread.

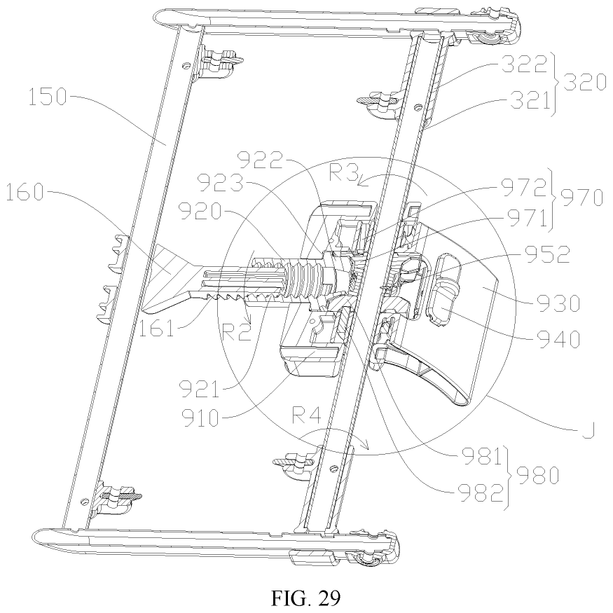

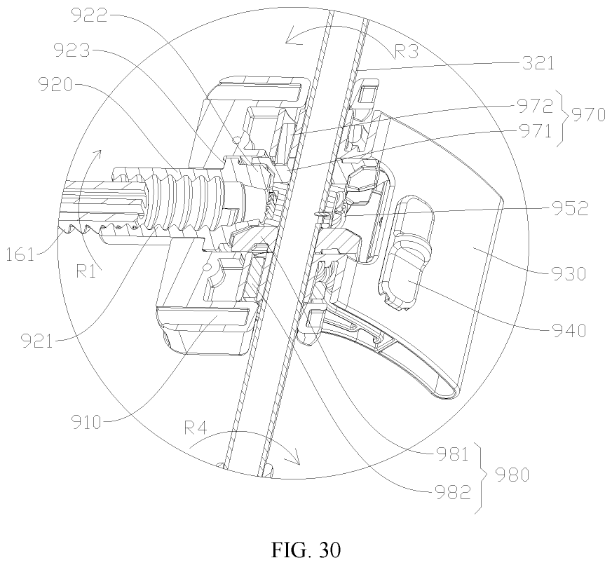

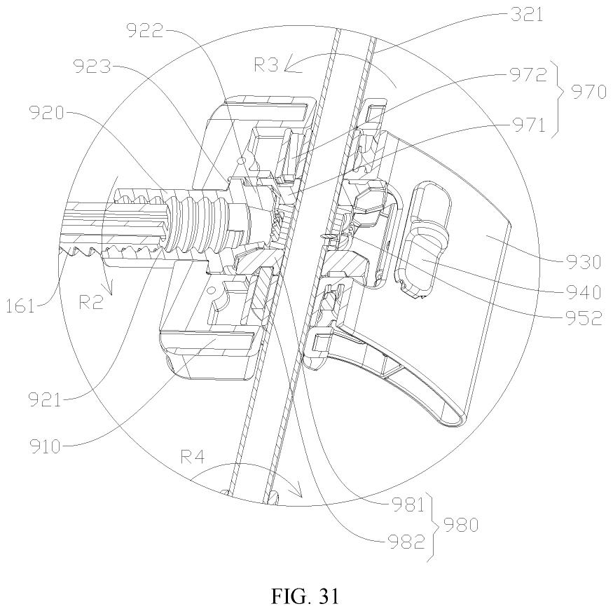

As shown in FIG. 28 to FIG. 31, the rotating member 920 can rotate along a first rotation direction R1 or a second rotation direction R2 relative to the fixed seat 910. The first rotation direction R1 is opposite to the second rotation direction R2. In this embodiment, as shown in FIG. 28 and FIG. 30, the first rotation direction R1 is clockwise. When the rotating member 920 rotates relative to the fixed seat 910 along the first rotation direction R1, through the threaded connection between the rotating member 920 and the connecting member 160, that is, a rotational threaded connection of the second thread 921 relative to the first thread 161, the rotating member 920 rotates along the first rotation direction R1 and moves close to the connecting rod 150, and then drives, through the fixed seat 910, the sliding rod 321 to move in a direction close to the connecting rod 150, and the height of the seat assembly 200 increases. As shown in FIG. 29 and FIG. 31, the second rotation direction R2 is counterclockwise. When the rotating member 920 rotates relative to the fixed seat 910 along the second rotation direction R2, through the threaded connection between the rotating member 920 and the connecting member 160, that is, rotational detachment of the second thread 921 relative to the first thread 161, the rotating member 920 rotates along the second rotation direction R2 and moves away from the connecting rod 150, and then drives, through the fixed seat 910, the sliding rod 321 to move in a direction away from the connecting rod 150, and the height of the seat assembly 200 decreases. As such, the threaded connection between the rotating member 920 and the connecting member 160 allows the sliding rod 321 and the connecting rod 150 to move close to or away from each other, thereby achieving stepless adjustment of the height of the seat assembly 200.

In embodiments not shown, set positions of the rotating member 920 and the connecting member 150 may alternatively be interchanged. That is, the rotating member 920 may be arranged on the connecting rod 150, and the connecting member 150 may be arranged on the fixed seat 910.

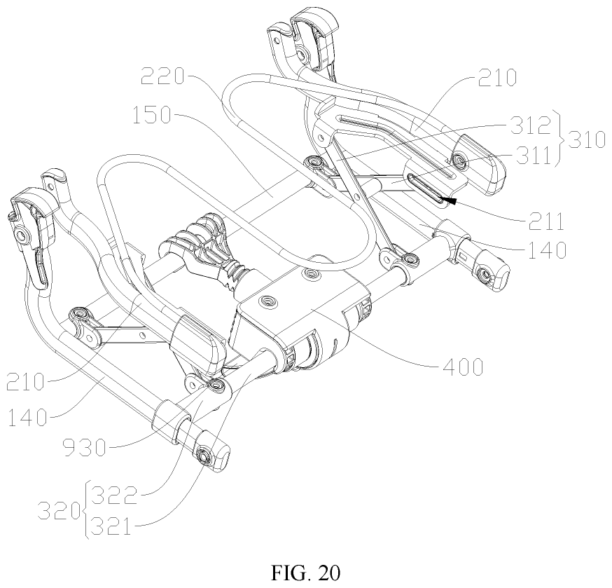

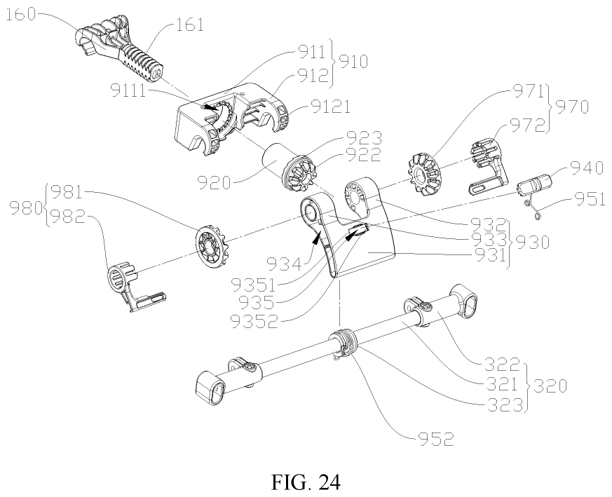

Further, as shown in FIG. 22 and FIG. 24, the first operating member 930 is a pull handle. The pull handle generally has a U-shaped housing structure, and includes a pull-handle body 931 and a first mounting portion 932 and a second mounting portion 933 connected to two ends of the pull-handle body 931. The first mounting portion 932 and the second mounting portion 933 both pass through the sliding rod 321 and may rotate relative to the sliding rod 321. In this embodiment, the first mounting portion 932 and the second mounting portion 933 are both located between the two second fixed portions 912 of the fixed seat 910. A hollow inner cavity 934 is provided inside the handle, and a substantially middle portion of the pull-handle body 931 is provided with an operating port 935 that can be communicated with the hollow inner cavity 934. The first operating member 930 is switchable between a first rotating position and a second rotating position relative to the sliding rod 321. In this embodiment, as shown in FIG. 20, the first rotating position of the first operating member 930 is located at a rear and lower position of the sliding rod 321. As shown in FIG. 21, the first rotating position of the first operating member 930 is located at a front and lower position of the sliding rod 321. It should be understood that the “upper”, “lower”, “front”, and “rear” referred to herein are based on upper and lower directions of the stroller in an unfolded state.

Further, as shown in FIG. 22 and FIG. 28, the fourth reset member 952 is adapted to bias the first operating member 930 to cause the first operating member 930 to move towards the first rotating position. Specifically, the fourth reset member 952 is a second torsion spring, a spring coil of the second torsion spring is wound and fixed to a fixed ring 323 located in a substantially middle portion of the sliding rod 321, and two free ends of the second torsion spring abut against the first mounting portion 932 and the second mounting portion 933 of the pull handle respectively. As shown in FIG. 20, in this embodiment, when not operated, the first operating member 930 may be at the rear and lower position of the sliding rod 321 under the action of the fourth reset member 952. The first operating member 930 at this position is not easily accidentally touched by an infant or a caregiver, thereby preventing accidental increase or decrease of the height of the seat assembly 200 caused by accidental touch of the first operating member 930.

Further, as shown in FIG. 22 and FIG. 24, the driving assembly is arranged between the first operating member 930 and the rotating member 920. In this embodiment, two driving assemblies may be provided, which are a first driving assembly 970 and a second driving assembly 980 respectively. Specifically, the first driving assembly 970 includes a first gear 971 and a first driving member 972, and the second driving assembly 980 includes a second gear 981 and a second driving member 982. As shown in FIG. 26, the first gear 971 and the second gear 981 are both located between the first mounting portion 932 and the second mounting portion 933 of the first operating member 930, and are respectively located on two sides of the third gear portion 922. The first driving member 972 and the second driving member 982 are both located in the hollow inner cavity 934 of the first operating member 930.

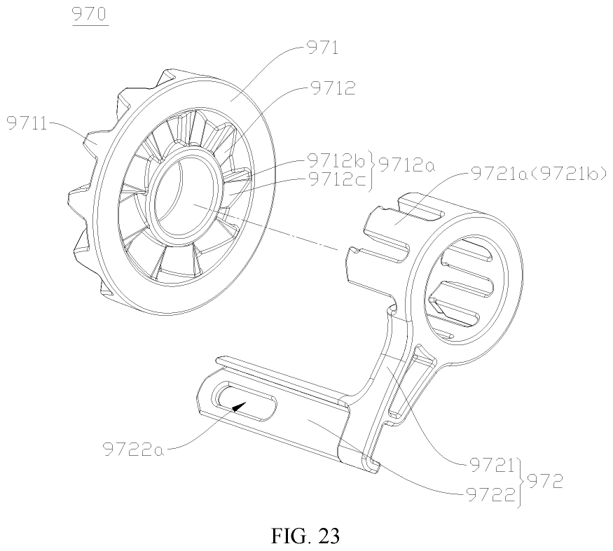

Specifically, as shown in FIG. 21 and FIG. 23, the first gear 971 substantially has a circular sheet-like structure, a surface of the first gear 971 facing the third gear portion 922 is provided with a first gear portion 9711 capable of meshing with the third gear portion 922, and a surface of the first gear 971 facing away from the third gear portion 922 is provided with a first auxiliary tooth portion 9712. The first driving member 972 substantially has an L-shaped structure, and includes a first driving body 9721 and a first movable end 9722 connected to each other. The first movable end 9722 is provided with a first guide groove 9722a. An end of the first driving body 9721 away from the first movable end 9722 has a first main tooth portion 9721a, and the first main tooth portion 9721a is in unidirectional meshing with the first auxiliary tooth portion 9712. Specifically, the first main tooth portion 9721a includes a plurality of first main teeth 9721b arranged circumferentially. The first auxiliary tooth portion 9712 includes a plurality of first auxiliary teeth 9712a arranged circumferentially. Each first auxiliary tooth 9712a includes a vertical first tooth surface 9712b and an inclined second tooth surface 9712c, and the second tooth surface 9712c is located in a third rotation direction R3 of the first tooth surface 9712b. As such, when the first driving member 972 rotates in the third rotation direction R3, the first driving member 972 can drive the first gear 971 to rotate through meshing of the first main tooth portion 9721a with the first auxiliary tooth portion 9712. Specifically, each first main tooth 9721b abuts against each first tooth surface 9712b to cause the first driving member 972 to push the first gear 971 to rotate accordingly. When the first driving member 972 rotates in a fourth rotation direction R4 opposite to the third rotation direction R3, the first driving member 972 cannot drive the first gear 971 to rotate through meshing of the first main tooth portion 9721a with the first auxiliary tooth portion 9712. Specifically, during rotation of the first driving member 972, each first main tooth 9721b slides along each second tooth surface 9712c so that the first driving member 972 cannot push the first gear 971 to rotate accordingly.

In this embodiment, as shown in FIG. 22 and FIG. 23, the first driving body 9721 is mounted in the hollow inner cavity 934 at the first mounting portion 932, and the first movable end 9722 is located in the hollow inner cavity 934 of the pull-handle body 931. The first guide groove 9722a of the first movable end 9722 is at least partially exposed through the operating port 935 (as shown in FIG. 26). The first driving member 972 is switchable between a first driving position and a first spacing position. When the first driving member 972 is at the first driving position, the first operating member 930 is operable to drive, through the first driving member 972, the first gear 971 to rotate. Specifically, when the first driving member 972 is at the first driving position, the first main tooth portion 9721a of the first driving member 972 can pass through the hollow inner cavity 934 and mesh with the first auxiliary tooth portion 9712 of the first gear 971 (as shown in FIG. 30). When the first driving member 972 is at the first spacing position, the first driving member 972 is spaced apart from the first gear 971. In this case, even if the first operating member 930 is operable, the first gear 971 cannot be driven through the first driving member 972 to rotate. Specifically, when the first driving member 972 is at the first spacing position, the first main tooth portion 9721a retracts to the hollow inner cavity 934 to be spaced apart from the first gear 971 (as shown in FIG. 31).

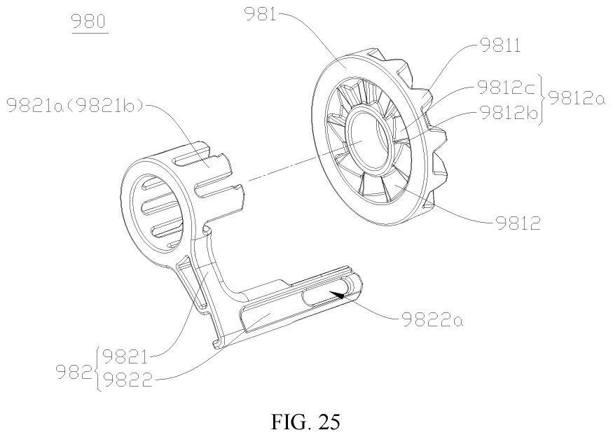

Further, as shown in FIG. 21, FIG. 24, and FIG. 25, structures of the second gear 981 and the second driving body 9821 are similar to those of the first gear 971 and the first driving body 9721 respectively. Specifically, the second gear 981 substantially has a circular sheet-like structure, a surface of the second gear 981 facing the third gear portion 922 is provided with a second gear portion 9811 capable of meshing with the third gear portion 922, and a surface of the second gear 981 facing away from the third gear portion 922 is provided with a second auxiliary tooth portion 9812. The second driving member 982 substantially has an L-shaped structure, and includes a second driving body 9821 and a second movable end 9822 connected to each other. The second movable end 9822 is provided with a second guide groove 9822a. An end of the second driving body 9821 away from the second movable end 9822 has a second main tooth portion 9821a, and the second main tooth portion 9821a is in unidirectional meshing with the second auxiliary tooth portion 9812. Specifically, the second main tooth portion 9821a includes a plurality of second main teeth 9821b arranged circumferentially, the second auxiliary tooth portion 9812 includes a plurality of second auxiliary teeth 9812a arranged circumferentially, each second auxiliary tooth 9812a includes a vertical third tooth surface 9812b and an inclined fourth tooth surface 9812c, and the fourth tooth surface 9812c is located in the third rotation direction R3 of the third tooth surface 9812b. As such, when the second driving member 982 rotates in the third rotation direction R3, the second driving member 982 can drive the second gear 981 to rotate through meshing of the second main tooth portion 9821a with the second auxiliary tooth portion 9812. Specifically, each second main tooth 9721b abuts against each third tooth surface 9812b to cause the second driving member 982 to push the second gear 981 to rotate accordingly. When the second driving member 982 rotates in the fourth rotation direction R4 opposite to the third rotation direction R3, the second driving member 982 cannot drive the second gear 981 to rotate through meshing of the second main tooth portion 9821a with the second auxiliary tooth portion 9812. Specifically, during rotation of the second driving member 982, each second main tooth 9821b slides along each fourth tooth surface 9812c so that the second driving member 982 cannot push the second gear 981 to rotate accordingly.

In this embodiment, as shown in FIG. 24 and FIG. 25, the second driving body 9821 is mounted in the hollow inner cavity 934 at the second mounting portion 933, and the second movable end 9822 is located in the hollow inner cavity 934 of the pull-handle body 931. The second guide groove 9822a of the second movable end 9822 is at least partially exposed through the operating port 935 (as shown in FIG. 26). The second driving member 982 is switchable between a second driving position and a second spacing position. When the second driving member 982 is at the second driving position, the first operating member 930 is operable to drive, through the second driving member 982, the second gear 981 to rotate. Specifically, when the second driving member 982 is at the second driving position, the second main tooth portion 9821a of the second driving member 982 can pass through the hollow inner cavity 934 and mesh with the second auxiliary tooth portion 9812 of the second gear 981 (as shown in FIG. 31). When the second driving member 982 is at the second spacing position, the second driving member 982 is spaced apart from the second gear 981. In this case, even if the first operating member 930 is operable, the second gear 981 cannot be driven through the second driving member 982 to rotate. Specifically, when the second driving member 982 is at the second spacing position, the second main tooth portion 9821a retracts to the hollow inner cavity 934 to be spaced apart from the second gear 981 (as shown in FIG. 30).

Further, the second operating member 940 is a push button movably arranged at the operating port 935 of the first operating member 930. The second operating member 940 is movable between a first operating position and a second operating position. In this embodiment, the first operating position may be indicated by a word “up” and the second operating position may be indicated by a word “down”. In other embodiments, the first operating position may be indicated by the word “down” and the second operating position may be indicated by the word “up”; or the first operating position and the second operating position may be indicated by markings of different colors or patterns, for example. In this embodiment, when the second operating member 940 is at the first operating position, the first operating member 930 is operable to drive, through the first driving assembly 970, the rotating member 920 to rotate relative to the connecting member 160 along the first rotation direction R1. When the second operating member 940 is at the second operating position, the first operating member 930 is operable to drive, through the second driving assembly 980, the rotating member 920 to rotate relative to the connecting member 160 along the second rotation direction R2.

Further, as shown in FIG. 23 and FIG. 28, when the second operating member 940 is at the first operating position, during rotation of the first operating member 930 from the first rotating position to the second rotating position along the third rotation direction R3, that is, when the first operating member 930 rotates upwards, the first driving member 972 is driven to rotate along the third rotation direction R3, the first driving member 972 may drive, through the meshing of the first main tooth portion 9721a with the first auxiliary tooth portion 9712, the first gear 971 to rotate along the third rotation direction R3, and then drive, through the meshing of the first gear portion 9711 with the third gear portion 922, the rotating member 920 to rotate along the first rotation direction R1. During resetting of the first operating member 930 to the first rotating position, that is, when the first operating member 930 rotates downwards, since the first main tooth portion 9721a is in unidirectional meshing with the first auxiliary tooth portion 9712, the first driving member 972 may not drive the first gear 971 to rotate along the fourth rotation direction R4. In this way, the first operating member 930 can be continuously rotated back and forth, so that the first gear 971 drives the rotating member 920 to continuously rotate along the first rotation direction R1, causing the height of the seat assembly 200 to continuously increase.

Similarly, as shown in FIG. 25 and FIG. 29, when the second operating member 940 is at the second operating position, during rotation of the first operating member 930 from the first rotating position to the second rotating position along the third rotation direction R3, that is, when the first operating member 930 rotates upwards, the second driving member 982 is driven to rotate along the third rotation direction R3, the second driving member 982 may drive, through the meshing of the second main tooth portion 9821a with the second auxiliary tooth portion 9812, the second gear 981 to rotate along the third rotation direction R3, and then drive, through the meshing of the second gear portion 9811 with the third gear portion 922, the rotating member 920 to rotate along the second rotation direction R2. During resetting of the first operating member 930 to the first rotating position, that is, when the first operating member 930 rotates downwards, since the second main tooth portion 9821a is in unidirectional meshing with the second auxiliary tooth portion 9821, the second driving member 982 may not drive the second gear 981 to rotate along the fourth rotation direction R4. In this way, the first operating member 930 can be continuously rotated back and forth, so that the second gear 981 drives the third gear to continuously rotate along the second rotation direction R2, causing the height of the seat assembly 200 to continuously decrease.

Specifically, as shown in FIG. 24 and FIG. 26, one end of the guide post 960 is fixed to the second operating member 940, the other end of the guide post 960 is inserted into the first guide groove 9722a and the second guide groove 9822a through the operating port 935, an extending direction of the operating port 935 is the same as moving directions of the first driving member 972 and the second driving member 982, the operating port 935 has a first sidewall 9351 and a second sidewall 9352, when the second operating member 940 is at the first operating position, the guide post 960 abuts against the first sidewall 9351. At the same time, the second operating member 940 drives the first driving member 972 to move from the first spacing position to the first driving position, and drives the second driving member 982 to move from the second driving position to the second spacing position. When the second operating member 940 is at the second operating position, the guide post 960 abuts against the second sidewall 9352. At the same time, the second operating member 940 drives the second driving member 982 to move from the second spacing position to the second driving position, and drives the first driving member 972 to move from the first driving position to the first spacing position.

Further, as shown in FIG. 24 and FIG. 26, the third reset member 951 is adapted to bias the second operating member 940 to constantly cause the second operating member 940 to move towards the first operating position or the second operating position. In this embodiment, the third reset member 951 is a torsion spring, one end of the torsion spring is fixed to the guide post 960, the other end of the torsion spring is fixed to the first operating member 930, and the torsion spring is adapted to bias the second operating member 940 to cause the second operating member 940 to move towards the first operating position.

In other embodiments not shown, the second operating member 940 may further have a third operating position. The third operating position may be, for example, located midway between the first operating position and the second operating position. When the second operating member 940 is at the third operating position, the rotating member 920 and the connecting member 160 are relatively fixed. That is, when the second operating member 940 is at the third operating position, the first driving member 972 and the second driving member 982 are respectively located at the first spacing position and the second spacing position. In this case, even if the first operating member 930 is operated, the first driving member 972 cannot drive the first gear 971 to rotate to drive the rotating member 920 to rotate, and the second driving member 982 cannot drive the second gear 981 to rotate to drive the rotating member 920 to rotate. In this way, the second operating member 940 provides a further safety locking mechanism for the locking mechanism 400, which can further prevent accidental raising or lowering of the seat assembly 400 caused by accidental touch of the second operating member 940. In this embodiment, the third reset member 951 is adapted to bias the second operating member 940 to cause the second operating member 940 to move towards the third operating position.

In other embodiments not shown, the first main tooth portion 9721a of the first driving member 972 may be in bidirectional meshing with the first auxiliary tooth portion 9712 of the first gear 971, while the first gear portion 9711 (which may alternatively serve as the third main tooth portion) may be in unidirectional meshing with the third gear portion 922 (which may alternatively serve as the third auxiliary tooth portion). Similarly, the second main tooth portion 9821a of the second driving member 982 may be in bidirectional meshing with the second auxiliary tooth portion 9812 of the second gear 981, while the second gear portion 9811 (which may alternatively serve as the fourth main tooth portion) may be in unidirectional meshing with the third gear portion 922 (which may alternatively serve as the fourth auxiliary tooth portion). In this way, the first operating member 930 can be continuously rotated back and forth, so that the first gear 971 or the second gear 981 drives the third gear portion 922 (the rotating member 920) to continuously rotate in the first rotation direction R1 or the second rotation direction R2, causing the height of the seat assembly 200 to continuously increase or decrease.

In other embodiments not shown, the first driving member 972 and the second driving member 982 may alternatively be omitted, and the third gear portion 922 is respectively in unidirectional meshing with the first gear portion 9711 and the second gear portion 9811. During rotation of the first operating member 930 from the second rotating position to the first rotating position, the third gear portion 922 is relatively fixed to the connecting member 160. During rotation of the first operating member 930 from the first rotating position to the second rotating position, the third gear portion 922 can rotate relative to the connecting member 160 along the first rotation direction R1 or the second rotation direction R2. In this way, the first operating member 930 can be continuously rotated back and forth, so that the first gear 971 or the second gear 981 drives the third gear portion 922 (the rotating member 920) to continuously rotate in the first rotation direction R1 or the second rotation direction R2, causing the height of the seat assembly 200 to continuously increase or decrease.

In other embodiments not shown, the first driving member 972 and the second driving member 982 may alternatively have an integrally formed structure. That is, the first driving member 972 and the second driving member 982 are a same component, which may be denoted as a driving member herein. The driving member generally has a U-shaped structure, and includes a movable portion and a first driving portion and a second driving portion connected to two ends of the movable portion. A substantially middle portion of the movable portion is provided with a guide groove, one end of the guide post 960 is fixed to the second operating member 940, and the other end of the guide post 960 is inserted into the guide groove through the operating port 935. Structures of the first driving portion and the second driving portion are substantially the same as those of the first driving body 9721 and the second driving body 9821 in the foregoing embodiments. That is, the first driving portion and the second driving portion are also respectively provided with the first main tooth portion 9721a and the second main tooth portion 9821a. In this way, when the second operating member 940 is at the first operating position, the guide post 960 abuts against the first sidewall 9351. At the same time, the second operating member 940 drives the first driving portion to move from the first spacing position to the first driving position, and drives the second driving portion to move from the second driving position to the second spacing position. When the second operating member 940 is at the second operating position, the guide post 960 abuts against the second sidewall 9352. At the same time, the second operating member 940 drives the second driving portion to move from the second spacing position to the second driving position, and drives the first driving portion to move from the first driving position to the first spacing position.

The height adjustment process of the seat assembly 200 of the above stroller is specifically as follows.

As shown in FIG. 23 and FIG. 28, when there is a need to increase the height of the seat assembly 200, the second operating member 940 may be first adjusted to the first operating position. In this case, the first driving member 972 moves from the first spacing position to the first driving position (in this case, the second driving member 982 moves from the second driving position to the second spacing position), and the first main tooth portion 9721a of the first driving member 972 abuts against the first auxiliary tooth portion 9712 of the first gear 971. In this case, if the first operating member 930 is operated, the first driving member 972 may be driven to rotate around the sliding rod 321, and at the same time, the first gear 971 is driven, through coordination between the first main tooth portion 9721a and the first auxiliary tooth portion 9712, to continuously rotate along the third rotation direction R3, thereby driving, through the meshing of the first gear portion 9711 with the third gear portion 922, the rotating member 920 to rotate along the first rotation direction R1. The rotating member 920 causes, through fitting of the second thread 921 thereof with the first thread 161 of the connecting member 160, the sliding rod 321 to move in a direction close to the connecting rod 150, thereby driving, through the support rod set 310, the seat assembly 200 to rise.

As shown in FIG. 25 and FIG. 29, when there is a need to decrease the height of the seat assembly 200, the second operating member 940 may be first adjusted to the second operating position. In this case, the second driving member 982 moves from the second spacing position to the second driving position (in this case, the first driving member 972 moves from the first driving position to the first spacing position), and the second main tooth portion 9821a of the second driving member 982 abuts against the second auxiliary tooth portion 9812 of the second gear 981. In this case, if the first operating member 930 is operated, the second driving member 982 may be driven to rotate around the sliding rod 321, and at the same time, the second gear 981 is driven, through coordination between the second main tooth portion 9821a and the second auxiliary tooth portion 9812, to continuously rotate along the third rotation direction R3, thereby driving, through the meshing of the second gear portion 9811 with the third gear portion 922, the rotating member 920 to rotate along the second rotation direction R2. The rotating member 920 causes, through fitting of the second thread 921 thereof with the first thread 161 of the connecting member 160, the sliding rod 321 to move in a direction away from the connecting rod 150, thereby driving, through the support rod set 310, the seat assembly 200 to fall. In this embodiment, through the unidirectional meshing of the first main tooth portion 9721a with the first auxiliary tooth portion 9712 and the unidirectional meshing of the second main tooth portion 9821a with the second auxiliary tooth portion 9812, the second operating member 940 can be operated repeatedly, so that the height of the seat assembly 200 can be continuously decreased or increased, thereby achieving stepless adjustment of the height of the seat assembly 200.

The above stroller has at least the following technical effects.

The seat assembly 200 of the stroller is movably arranged on the stroller frame 100, and the height of the seat assembly 200 can be adjusted through the support rod set 310 movably connected between the stroller frame 100 and the seat assembly 200, which can meet the children's requirements of observing the surrounding environments with different fields of view and can also be suitable for children of different heights to sit on. Through the locking mechanism 400, the support rod set 310 can be locked or unlocked, so that the user can unlock the support rod set 310 for adjustment when needing to adjust the height of the seat assembly 200 or can lock the support rod set 310 when adjusting the seat assembly 200 to an appropriate height, causing the seat assembly 200 to be fixed to the appropriate height.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the invention. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1-47. (canceled)

48. A stroller, comprising:
a stroller frame;
a seat assembly movably arranged on the stroller frame and configured to carry a child;
a support rod set movably connected to the stroller frame and the seat assembly respectively, the support rod set being configured to adjust a height of the seat assembly; and
a locking mechanism selectively locking or unlocking the support rod set so that the seat assembly is fixed at a height position or the height of the seat assembly is adjustable.

49. The stroller according to claim 48, wherein the support rod set comprises a first lifting rod and a second lifting rod that are pivotally connected to each other, two ends of the first lifting rod are movably connected to the stroller frame and the seat assembly respectively, and two ends of the second lifting rod are movably connected to the stroller frame and the seat assembly respectively.

50. The stroller according to claim 49, further comprising a sliding assembly, the stroller frame comprising a support rod horizontally arranged, the sliding assembly being slidable relative to the support rod, one end of the second lifting rod being pivotally connected to the sliding assembly, and the other end of the second lifting rod being pivotally connected to the seat assembly.

51. The stroller according to claim 50, wherein the sliding assembly comprises a sliding rod and a sliding seat, the sliding seat being fixed to one end of the sliding rod, the sliding seat further sleeving the support rod and being slidable along the support rod, and one end of the second lifting rod is pivotally connected to the sliding seat.

52. The stroller according to claim 49, wherein one end of the first lifting rod is pivotally connected to the stroller frame, the seat assembly is provided with a sliding groove, and a sliding pin is fixed to the other end of the first lifting rod, the sliding pin being inserted into the sliding groove and movable along the sliding groove.

53. The stroller according to claim 48, further comprising a sliding assembly, the sliding assembly being slidable relative to the stroller frame, the locking mechanism being arranged on the sliding assembly, and the locking mechanism selectively fixing the sliding assembly relative to the stroller frame or enabling the sliding assembly to slide relative to the stroller frame.

54. The stroller according to claim 53, wherein the locking mechanism comprises:
a locking member movable arranged in the sliding assembly; and
an operating member arranged on the sliding assembly and drivingly connected to the locking member;
wherein the stroller frame is provided with a plurality of locking recesses, and the operating member is operable to cause the locking member to be disengaged from any of the locking recesses.

55. The stroller according to claim 54, wherein the stroller frame comprises a support rod arranged horizontally, the plurality of locking recesses being disposed on the support rod and arranged along a length direction of the support rod, and when the operating member is operated, the locking member is disengaged from any of the locking recesses, and the sliding assembly is slidable along the support rod.

56. The stroller according to claim 54, wherein the locking mechanism further comprises a first reset member, the first reset member biasing to cause the locking member to move in a direction of engaging with any of the locking recesses.

57. The stroller according to claim 48, further comprising an anti-accidental touch mechanism, the anti-accidental touch mechanism having a locked state and an unlocked state, when the anti-accidental touch mechanism is in the locked state, the locking mechanism keeping locking the support rod set, and when the anti-accidental touch mechanism is in the unlocked state, the locking mechanism being operable to unlock the support rod set.

58. The stroller according to claim 53, wherein the locking mechanism comprises:
a first operating member;
a connecting member provided with a first thread; and
a rotating member provided with a second thread in a threaded connection with the first thread; and
a driving assembly arranged between the first operating member and the rotating member;
wherein the first operating member is operable to drive, through the driving assembly, the rotating member to rotate relative to the connecting member.

59. The stroller according to claim 58, wherein the locking mechanism further comprises:
a second operating member having a first operating position and a second operating position; and
two driving assemblies are provided, which are a first driving assembly and a second driving assembly respectively,
wherein, when the second operating member is at the first operating position, the first operating member is operable to drive, through the first driving assembly, the rotating member to rotate relative to the connecting member along a first rotation direction, and when the second operating member is at the second operating position, the first operating member is operable to drive, through the second driving assembly, the rotating member to rotate relative to the connecting member along a second rotation direction, the first rotation direction being opposite to the second rotation direction.

60. The stroller according to claim 59, wherein the other end of the rotating member away from the second thread is provided with a third gear portion;
the first driving assembly comprises:
a first driving member in driving fit with the second operating member; and
a first gear having a first gear portion capable of meshing with the third gear portion; and
the second driving assembly comprises:
a second driving member in driving fit with the second operating member; and
a second gear having a second gear portion capable of meshing with the third gear portion;
wherein, when the second operating member is at the first operating position, the first operating member is operable to cause, through the first driving member, the first gear to drive the third gear portion to rotate along the first rotation direction, and when the second operating member is at the second operating position, the second operating member is operable to cause, through the second driving member, the second gear to drive the third gear portion to rotate along the second rotation direction.

61. The stroller according to claim 59, wherein the second operating member further has a third operating position, and when the second operating member is at the third operating position, the first operating member is operated, and the rotating member and the connecting member are relatively fixed.

62. The stroller according to claim 60, wherein the first gear portion meshes with the third gear portion, the first driving member is switchable between a first driving position and a first spacing position, when the first driving member is at the first driving position, the first operating member is operable to drive, through the first driving member, the first gear to rotate, and when the first driving member is at the first spacing position, the first driving member is spaced apart from the first gear; and
the second gear portion meshes with the third gear portion, the second driving member is switchable between a second driving position and a second spacing position, when the second driving member is at the second driving position, the first operating member is operable to drive, through the second driving member, the second gear to rotate, and when the second driving member is at the second spacing position, the second driving member is spaced apart from the second gear.

63. The stroller according to claim 62, wherein, when the second operating member moves to the first operating position, the second operating member drives the first driving member to move from the first spacing position to the first driving position, and the second operating member drives the second driving member to move from the second driving position to the second spacing position; and when the second operating member moves to the second operating position, the second operating member drives the first driving member to move from the first driving position to the first spacing position, and the second operating member drives the second driving member to move from the second spacing position to the second driving position.

64. The stroller according to claim 63, wherein the locking mechanism further comprises a third reset member, the third reset member being adapted to bias the second operating member to cause the second operating member to move towards the first operating position or the second operating position.

65. The stroller according to claim 60, wherein the third gear portion is in unidirectional meshing with the first gear portion and the second gear portion respectively; or the first gear is in unidirectional meshing with the first driving member, and the second gear is in unidirectional meshing with the second driving member.

66. The stroller according to claim 65, wherein the first operating member is rotatably arranged on the sliding assembly, the first driving member and the second driving member are both arranged outside the sliding assembly and rotate coaxially with the first operating member, the first operating member is switchable between a first rotating position and a second rotating position, when the second operating member is at the first operating position, during rotation of the first operating member from the first rotating position to the second rotating position, the first driving member drives the first gear to rotate synchronously, and during rotation of the first operating member from the second rotating position to the first rotating position, the first gear is relatively fixed to the sliding assembly; and when the second operating member is at the second operating position, during rotation of the first operating member from the first rotating position to the second rotating position, the second driving member drives the second gear to rotate synchronously, and during rotation of the first operating member from the second rotating position to the first rotating position, the second gear is relatively fixed to the sliding assembly.

67. The stroller according to claim 66, wherein the locking mechanism further comprises a fourth reset member, the fourth reset member being adapted to bias the first operating member to cause the first operating member to move from the second rotating position to the first rotating position.
